(19) United States
(12) Patent Application Publication
(10) Pub. No.: US 2025/0058279 A1
(43) Pub. Date: Feb. 20, 2025

(54) ARRANGEMENT AND PLATE FOR CONDENSING A GASEOUS LIQUID INTO LIQUID STATE

(71) Applicant: Aktiebolaget Scarab Development, Stockholm (SE)

(72) Inventors: Alaa KULLAB, Stockholm (SE); Aapo SÄÄSK, Stockholm (SE)

(73) Assignee: Aktiebolaget Scarab Development, Stockholm (SE)

(21) Appl. No.: 18/721,646

(22) PCT Filed: Dec. 21, 2022
(86) PCT No.: PCT/SE2022/051225

§ 371 Date: Jun. 18, 2024

(30) Foreign Application Priority Data
Dec. 22, 2021 (SE) 2151610-9

(51) Int. Cl. B01D 61/36

(52) U.S. Cl. CPC B01D 61/366; B01D 61/364; B01D 2313/221

(57) ABSTRACT

The technology disclosed relates to an arrangement for membrane distillation made of at least one plate including a structure having at least one depression or cavity. A membrane is an integral/integrated part of the plate structure or is joined to surface portions of a first side of the structure of the at least one plate so that the joined membrane is substantially parallel with and is facing a relatively thin wall constituting at least some of the more central portions of the plate structure. The surface portions of the membrane are directly joined to the surface portions of the plate structure to form a compartment configured for condensing gas into liquid. Two plates may be directly joined to each other to form a compartment for a warm-liquid channel and/or two plates may be joined to each other to form a compartment for a cooling channel.

### TECHNICAL FIELD

The technology disclosed relates to an arrangement for at least one of separating and purifying a liquid and which includes at least one plate having at least one depression or cavity and a membrane through which a fluid can pass only when it is in the gaseous phase and where the membrane is an integral part of or is directly joined to surface portions of the plate structure to thereby form and define a compartment configured for condensing gas into liquid.

In aspects and embodiments, the technology disclosed also relates to an arrangement comprising two plates which are joined to each other on the same side as the membrane is joined to the respective plate and where the joining of the two plates forms and defines a compartment of a warm-liquid channel including the two membranes. The compartment formed compartment for a warm-liquid channel is configured for carrying relatively warmer liquid along two substantially parallel and opposing membranes, where each membrane is constituting substantial portions of a relatively thin wall of the respective compartment for condensing gas into liquid.

In aspects and embodiments, the technology disclosed further relates to an arrangement comprising two plates each comprising a relatively thin wall and which are joined to form and define a compartment of a cooling channel configured for providing efficient heat transfer through the relatively thin walls for cooling of two separate inner surfaces of two separate compartments for condensing gas into liquid, i.e. condensing a gaseous liquid substance into liquid state.

### BACKGROUND

It is known to use membrane distillation for the cleaning of water for household use, desalting seawater for a purpose, cleaning water for use within several industrial fields, or concentrating undesired substances, i.e. a byproduct, to as small a volume as possible, or indeed to a solid material.

A number of arrangements are currently available for achieving these purposes. A common arrangement is a boiler arrangement in which the temperature is allowed to rise until the water boils away, leaving an essentially solid material. Furthermore, the water that has boiled off can condense and be collected to be used as clean water.

The Swedish patent number 8002233-8 reveals an example arrangement to achieve these purposes, and which is directed to make use of a method before the boiling procedure is carried out, such as membrane distillation. This has been known since the 1980s as a method of cleaning water.

As mentioned above, membrane distillation can be used in many fields. Seawater, for example, can be allowed to flow along the membrane, and the water that has vaporised to pass through the membrane and to be collected on the other side of the membrane and to be used as clean water. In this way, all substances, except for pure water, remain in the water that is to be cleaned. There are several areas of use for membrane distillation. It may conceivably be wastewater that is to be cleaned, not only to clean the water to use clean water in industries that require clean water, but also to clean the water such that an essentially solid byproduct of undesired substances remains. A pump is normally used in the arrangements to pump the water around.

Membrane distillation (MD) is an arrangement for allowing a first liquid to pass close to a second liquid, while not mixing with it, which arrangement at least in the past, comprises a number of flat sheets joined together with gaskets for ensuring sealing performance. A first sheet is provided with a membrane through which water can pass only when it is in the gaseous phase. Temperature differences between sheets cause the water to vaporise, to pass through the membrane and to condense onto a second wall, which is colder than the water that is to be cleaned. The surface tension of the water ensures that the water cannot pass through the membrane.

Swedish patent SE 507728 describes a system for heat transport comprising a first heat exchanger, a supply line that is intended to lead a heat-bearing fluid in two parallel columns of fluid to the first heat exchanger in order there to absorb heat. Furthermore, SE 507728 reveals a second heat exchanger that has been arranged to vaporise fluid in a partial flow from the first column of fluid to the second column of fluid, whereby gas bubbles flow up through the first column of fluid and achieve flow of the fluid.

In Direct-contact membrane distillation (DCMD), both sides of the membrane are charged with liquid hot feed water on the evaporator side and cooled permeate on the permeate side. The condensation of the vapour passing through the membrane happens directly inside the liquid phase at the membrane boundary surface. Since the membrane is the only barrier blocking the mass transport, relatively high surface related permeate flows can be achieved with DCMD. A disadvantage is the high sensible heat loss, as the insulating properties of the single membrane layer are low. However, a high heat loss between evaporator and condenser is also the result of the single membrane layer. This lost heat is not available to the distillation process, thus lowering the efficiency.

Air gap membrane distillation (AGMD) is a membrane distillation technology characterized by the presence of an air gap between the membrane surface and a cooled condensing surface in order to reduce the heat losses due to the conduction through the membrane. The mass transfer in AGMD occurs from the hot feed stream to the hot membrane interface through the feed boundary layer, through the membrane pores, and from the less hot membrane interface to the surface of the condensing film through the air gap. In air gap membrane distillation (AGMD) technology, the permeate gap thus lies between the membrane and a cooled surface and is filled with air.

In air gap membrane distillation (AGMD) technology, vapour passing through the membrane must additionally overcome the air gap before condensing on a cooler surface. Some of the advantages of this method compared to other MD technologies is the high thermal insulation towards the condenser channel, thus minimizing heat conduction losses.

A further advantage with AGMD over other MD technologies is that volatile substances with a low surface tension such as alcohol or other solvents can be separated from diluted solutions, due to the fact that there is no contact between the liquid permeate and the membrane with AGMD. AGMD is especially advantageous compared to alternatives at higher salinity. Variations on AGMD can include hydrophobic condensing surfaces for improved flux and energy efficiency.

Swedish patent SE 701600 describes an arrangement for producing clean water, in which water that is to be cleaned undergoes membrane distillation by means of one or several units comprising a first wall that is impermeable to water and that has the form of a sheet, a membrane through which water in the gaseous phase can pass, and through which water in fluid phase cannot pass, and a second wall in the form of a sheet, which walls are located on different sides of and at a certain distance from the membrane, where it is intended that water is to be led in between the first wall and the membrane

In the arrangement disclosed in SE 701600, the second wall is arranged such that it is colder than the water in that the first wall is arranged to be exposed to the surroundings for the absorption of heat energy from Illumination by solar radiation.

Swedish patent SE 701601 describes an arrangement for producing clean water, in which water that is to be cleaned undergoes membrane distillation by means of one or several units comprising a first wall that is impermeable to water and that has the form of a sheet, a membrane through which water in the gaseous phase can pass, and through which water in fluid phase cannot pass, and a second wall in the form of a sheet, which walls are located on different sides of and at a certain distance from the membrane, where it is intended that water is to be led in between the first wall and the membrane. In the arrangement disclosed in SE 701601, the second wall is arranged such that it is colder than the water in that the first wall is arranged to be heated by electricity.

In SE 701601, distillation is caused to use differences in partial pressure with the aid of a hydrophobic membrane through which membrane only clean water in a gaseous state is allowed to pass, whereby a water residual with an elevated content of contaminants does not pass through the membrane, and where the water residual is caused to be transferred to a boiler arrangement. The steam that is formed during the boiling procedure is caused to be led to a heat exchanger in which the steam is heat exchanged with a colder flow of cooling medium such that the steam is caused to condense. The condensed steam that is released during the condensation process in the heat exchanger is caused to be added to the water that is to be cleaned in the membrane distillation arrangement.

CN 210964665 shows an embodiment of a condensation enhanced air gap membrane distillation structure. The air gap type membrane distillation structure disclosed in CN 210964665 is aimed for strengthening condensation and comprises three zones: a high-temperature feed liquid channel separated by a first partition plate and a distillation membrane, feed liquid flows through the channel, and where the feed liquid belongs to high-temperature feed liquid. The middle part is a heat exchange area formed by separating the distillation membrane and a separate cooling plate, and the middle part of the heat exchange area is provided with a separate cooling fin. The cooling fin contact the cooling plates but are spaced from the distillation membranes by an air gap, and the space between the heat conducting structure and the distillation membranes is filled with water. The water produced in the heat transfer zone flows out from below. The right side is a low-temperature material liquid channel separated by a cooling plate and a second partition plate, and the low-temperature material liquid flows out from the region, is heated by a heater and then flows into the high-temperature material liquid channel. In the heat exchange zone, the space between the distillation membrane and the cooling plate is filled with water.

### Problems With the Prior Art

In prior art arrangement for membrane distillation, essentially flat sheets or frames are typically held together using gaskets and separate cooling sheets, plates or fins are used for cooling purposes.

However, sealing using gaskets is not perfect, and in prior art arrangements for membrane distillation, there are so many inlets and outlets that may leak, and leakage is a common form of failure.

Other problems with prior art modules for membrane distillation using gaskets and various different types of frames and separate cooling sheets/fins include that the risk of particles and other contaminants entering the module is significant, i.e. particles and other contaminants entering the hot-liquid channel and/or the ultrapure water compartment.

Moreover, the use of gaskets and the extensive stacking of various and different types of frames and separate cooling sheets/fins makes the prior art modules large, complex, difficult to assemble and expensive to manufacture.

### SUMMARY

The technology disclosed relates to an arrangement and plate for condensing a gaseous liquid into liquid state.

The object of the technology disclosed is to provide an arrangement and plate configured to reduce the risk of leakage and to reduce the risk of external particles and other contaminants entering the arrangement.

Further objects of the technology disclosed is to provide an arrangement and plate that is compact, resilient, easy to assemble and less expensive to manufacture than prior art modules.

The technology disclosed relates to an arrangement, or module, for use in a thermal pervaporation process for at least one of separating and purifying a liquid by increasing the temperature of the liquid so that some of the liquid ions evaporate which increases the partial pressure over the liquid surface causing a transport of ions to a cool inner surface of a compartment where the vapor condenses. The pressure difference between the expanding vapor and the condensing vapor creates a steady flow of vapor. The heated liquid surface is kept in place by a liquid phobic membrane (hydrophobic membrane in the case of using water as the liquid) through which the vapor travels. Typically, substantially all non-volatiles stay in the liquid because of the surface tension of the liquid. The above specific unit operation performed by the arrangement, or module, of the technology disclosed may be referred to as thermal pervaporation.

The technology disclosed relates to an arrangement and plate for thermal pervaporation. In aspects, the technology disclosed relates to an arrangement for thermal pervaporation and a plate for a module for thermal pervaporation.

The technology disclosed relates to an arrangement for at least one of separating and purifying a liquid and which includes at least one liquid phobic membrane (hydrophobic membrane in the case of using water as the liquid) through which a fluid can pass only when it is in the gaseous phase and where surface portions of the membrane are directly joined to the surface portions of the plate structure (or an integral/integrated part of the plate structure) to thereby form and define a compartment configured for condensing gas into liquid.

In aspects, the technology disclosed relates to an arrangement for at least one of separating and purifying a liquid consisting of at least one plate comprising a structure and where the arrangement further includes a liquid phobic membrane (hydrophobic membrane in the case of using water as the liquid) through which gaseous liquid can pass but not fluid in liquid form, wherein surface portions of the membrane are joined to surface portions of a first side of the structure of the at least one plate so that the joined membrane is substantially parallel with and is facing a relatively thin wall constituting at least some of the more central portions of the plate structure, and wherein the surface portions of the membrane are directly joined to the surface portions of the plate structure to form a compartment for condensing gas into liquid.

In embodiments, the first side of each of the at least one plate is provided with at least one depression or cavity, and wherein surface portions of the membrane are joined to surface portions surrounding the at least one depression or cavity to thereby form and define the compartment for condensing gas into liquid.

In embodiments, surface portions of the membrane are joined to the first side in a closed joining line surrounding the at least one depression or cavity to thereby form and define a sealed compartment for condensing gas into liquid.

In embodiments, the structure of the at least one plate comprises at least one outlet for conveying fluid away from the compartment for condensing gas into liquid, and wherein the at least one outlet constitutes an integral part of the plate structure, thereby minimizing the risk of leakage and significantly reducing the risk of external particles and other contaminants entering the at least one of separated and purified liquid conveyed away from the compartment for condensing gas into liquid.

In embodiments, surface portions of the membrane are joined to surface portions of the first side so that the distance along a substantially normal axis to plane of the relatively thin wall to the membrane forms and defines the air gap of the compartment for condensing gas into liquid.

In embodiments, surface portions of the same first side of the structure of one plate are joined to outer peripheral surface portions of the first side of the structure of another second plate comprising a membrane to thereby form, in addition to the compartments for condensing gas into liquid, a first type of compartment of a warm-liquid channel for carrying relatively warmer liquid, wherein the formed first type of compartment of a warm-liquid channel is configured so that relatively warmer liquid may pass along two substantially parallel and inside the compartment of the warm-liquid channel opposing liquid phobic membranes (hydrophobic membrane in the case of using water as the liquid) of the two respective compartments for condensing gas into liquid. Hence, the relatively warmer liquid running through the one warm-liquid channel formed by the joining of the two plates passes along two separate liquid phobic membranes of two separate compartments for condensing gas into liquid. By increasing the temperature of the liquid so that some of the ions, for example water ions in the case of using water as the liquid, evaporate which increases the partial pressure over the liquid surface causing a transport of ions to a cool inner surface of a compartment where the vapor condenses. The pressure difference between the expanding vapor and the condensing vapor creates a steady flow of vapor. The heated liquid surface is kept in place by a liquid phobic membrane (hydrophobic membrane in the case of using water as the liquid) through which the vapor travels. Typically, substantially all non-volatiles stay in the liquid because of the surface tension of the liquid, for example water. The above specific unit operation performed by the arrangement, or module, of the technology disclosed may be referred to as thermal pervaporation.

In embodiments, two plates whose joining form and define the compartment of the warm-liquid channel are joined together on the same first side of the respective plate as the first side to which the respective membrane is joined to the respective plate.

In embodiments, surface portions of two plates are joined to each other on the same first side of the respective plate structure as the respective membrane is joined to the respective plate, and wherein the distance between the two membranes along a substantially normal axis to the plane of the respective membrane defines the gap of the compartment of the warm-liquid channel. In certain embodiments, the two plates are joined to each other to also form and define at least one inlet and at least one outlet for the compartment of the warm-liquid channel. The plates may then be directly joined to each other to form the compartment of the warm-liquid channel without any intermediate gaskets, thereby reducing or eliminating the risk of leakage and contamination.

In embodiments, surface portions of the second side of the first side of the structure of one plate are joined to surface portions of the second side of the structure of another third plate different from the second plate to thereby define a second type of compartment of a cooling channel for carrying a cooling fluid, wherein the configuration of the compartment of a cooling channel and the thickness of the relatively thin wall of the respective plate are adapted for cooling of an inner surface of the respective compartment for condensing gas into liquid by heat transfer from the cooling fluid through the relatively thin wall constituting at least some of the more central portions of the structure of the respective plate. The two plates may be joined to each other to also form and define at least one inlet and at least one outlet for the compartment of the cooling channel. The plates may be directly joined to each other to form the compartment of a cooling channel without any intermediate gaskets, thereby reducing or eliminating the risk of leakage.

In embodiments, the structure of the at least one plate is configured so that the thickness of at least some of the more central portions of the structure of the at least one plate defines a relatively thin first wall adapted for transferring heat from a cooling fluid of a cooling channel through the thin wall to cool down an inner surface of the compartment for condensing gas into liquid.

In certain embodiments, the thickness of the at least some of the more central portions of the plate structure defining a relatively thin first wall of the at least one plate is less than 2 mm, wherein the relatively thin wall is thereby adapted for efficient heat transfer for cooling of the inner surface of the compartment for condensing gas into liquid.

In certain embodiments, the thickness of the at least some of the more central portions of the plate structure defining a relatively thin first wall of the at least one plate is less than 1 mm, wherein the relatively thin wall is thereby adapted for efficient heat transfer for cooling of the inner surface of the compartment for condensing gas into liquid.

In embodiments, the at least some of the more central portions of the plate structure defining the relatively thin first wall of the at least one plate is at least partly made of a separate material from the material of the rest of the plate structure.

In embodiments, the at least some of the more central portions of the plate structure defining the relatively thin first wall of the at least one plate is at least partly made of a metallic material coated with a film of a non-metallic material.

In embodiments, the relatively thin first wall of the at least one plate is at least partly defined by a sheet at least partly made of a separate material from the polymer material of the rest of the plate structure, and wherein the sheet is joined to or is an integral part of the plate structure. In certain embodiments, the sheet or applied thin layer at least partly made of a metallic material at least partly forms and defines the relatively thin first wall of the at least one plate. In certain embodiments, the sheet or applied thin layer is at least partly made of a metallic material is an integral part of the plate structure.

In embodiments, the arrangement further comprises a collection container joined to the plate structure and connected to the at least one outlet for conveying fluid away from the respective compartment for condensing gas into liquid, wherein the collection container is directly joined to the plate structure and is adapted for collecting fluid from the compartment for condensing gas into liquid.

In certain embodiments, the collection container is directly joined to the plate structure without any intermediate gaskets for connecting the at least one outlet for conveying fluid away from the respective compartment for condensing gas into liquid to the collection container, thereby reducing or eliminating the risk of leakage and contamination.

In embodiments, two different types of compartments of a cooling channel and a warm-liquid channel which comprises the respective at least one inlet and at least one outlet of each compartment are each defined by the respective directly joined two plates so that each unit for condensing gas into liquid is directly defined by the joined plates without any intermediate gaskets for the inlets and outlets for the respective compartment, thereby reducing or eliminating the risk of leakage and contamination from inside and outside the arrangement.

The technology disclosed also relates to a plate having a structure and configured to be joined to a membrane through which gaseous liquid can pass through but not fluid in liquid form, wherein the structure of a first side of the plate is configured so that a membrane that is joined to the first side is substantially parallel with and is facing a relatively thin wall constituting at least some of the more central portions of the plate and the distance between the relatively thin wall and the membrane defines the air gap of a compartment for condensing gas into liquid.

In embodiments, the first side of the plate is provided with a cavity, wherein the cavity is configured so that, when surface portions of a membrane are joined to surface portions surrounding the cavity in the first side of the plate, a compartment for condensing gas into liquid is formed.

In certain embodiments, the cavity in the first side of the plate is configured so that, when surface portions of the membrane are joined to the first side in a closed joining line surrounding the cavity, a sealed compartment for condensing gas into liquid is formed. The plate may comprise at least one outlet of a compartment for condensing gas into liquid which then constitutes an integral part of the structure.

In embodiments, the plate may comprise a membrane part which is at least one of injection moulded and 3D printed to be an integral part of the structure.

The above arrangement and plate of the technology disclosed are designed to reduce the risk of leakage and provide protection from external particles, substances and other contaminants entering the arrangement, yet providing a structure for efficient heat transfer for cooling the inner surface of a compartment for condensing a gas into liquid, i.e. condensing a gaseous liquid into liquid state.

The intelligent design of the above plate according to embodiments of the technology disclosed where a first side of the plate is provided with at least one depression or a cavity enables that another plate may be joined to surface portions on the same first side of the plate structure as the membrane is directly joined to (or is an integral part of) to thereby form a compartment for a warm-liquid channel in addition to the compartment(s) for condensing gas into liquid.

### BRIEF DESCRIPTION OF DRAWINGS

Preferred embodiments of an arrangement according to the technology disclosed will be described more in detail below with reference to the accompanying drawings wherein:

FIG. 1 illustrates a front view of an example embodiment of the arrangement and an example structure of a plate according to the technology disclosed.

FIG. 2 illustrates a schematic side view of a plate and a membrane according to embodiments of the technology disclosed.

FIG. 3 illustrates a schematic side view of an example arrangement comprising a membrane joined to a plate according to embodiments of the technology disclosed.

FIG. 4 illustrates a schematic side view of an example arrangement according to embodiments of the technology disclosed where a first side of two plates are joined together to form a second type of compartment for a warm-liquid channel.

FIG. 5 illustrates a schematic side view of an example arrangement according to embodiments of the technology disclosed where a second side of two plates are joined together to form a second type of compartment for a cooling channel

FIG. 6 illustrates a schematic side view of an example arrangement according to the technology disclosed comprising four plates whose joining has formed and defined four separate compartments for condensing gas into liquid.

FIG. 7 illustrates a schematic side view of an example arrangement according to the technology disclosed comprising two end plates and six mutually similar plates whose joining has formed and defined six compartments for condensing gas into liquid.

### DETAILED DESCRIPTION

In the drawings, similar details are denoted with the same reference number throughout the different embodiments. In the various embodiments of the arrangement for at least one of purifying and separating a liquid according to the technology disclosed, the different subsystems are denoted. The “boxes”/subsystems shown in the drawings are by way of example only and can within the scope of the technology disclosed be arranged in any other way or combination. In the drawings, similar details are denoted with the same reference number throughout the different embodiments.

The term liquid phobic membrane, as used in this disclosure, is meant a membrane that is phobic to a particular liquid caused to flow through the warm-liquid channel of the arrangement, or module, of the technology disclosed. Hence, the module, or arrangement, according to the technology disclosed comprises a warm-liquid channel and further includes a liquid phobic membrane that is phobic to a particular liquid flowing through the warm-liquid channel.

Membrane distillation (MD) is a thermally driven separation process in which separation is driven by phase change. A liquid phobic membrane presents a barrier for the liquid phase, allowing the vapour phase (e.g. water vapour) to pass through the membrane's pores. The driving force of the process is a partial vapour pressure difference commonly triggered by a temperature difference.

The technology disclosed relates to a plate and an arrangement for at least one of separating and purifying a liquid.

In particular, the technology relates to a plate and an air gap membrane distillation arrangement, or module, using thermal pervaporation for at least one of separating and purifying a liquid.

In aspects, the membrane arrangement according to the technology disclosed comprises at least one plate and allows for a first fluid to pass close to a second cooling fluid, while not mixing with it. The first fluid that is to be purified or separated can pass through the membrane only when it is in the gaseous phase. According to the embodiments of the technology disclosed, temperature differences cause the first fluid to vaporise, to pass through the membrane and to condense onto a relatively thin wall, which is colder than the first fluid. The surface tension of the first fluid ensures that the fluid in liquid form cannot pass through the membrane.

The arrangement, or module, for at least one of separating and purifying a liquid is consisting of at least one plate comprising a structure. The arrangement includes a membrane through which gaseous liquid can pass through but not fluid in liquid form, where surface portions of the membrane are joined to surface portions between more central portions including a cavity and more peripheral surface of a first side of the structure of the at least one plate so that the joined membrane defines an air gap of a substantially sealed compartment or chamber. The joined membrane is substantially parallel with and is facing a relatively thin wall constituting at least some of the more central surface portions of the plate structure, e.g. constituting a cavity bottom in the first side of the plate. The peripheral surface portions of the membrane may be directly joined to the surface portions of the plate structure to thereby form and define a compartment configured for condensing gas into liquid.

In aspects, the technology disclosed relates to a plate and an arrangement for condensing a gaseous liquid into liquid state and which is configured to reduce the risk of leakage and the risk of at least one of external particles, substances and other contaminants entering the arrangement, yet providing a structure for efficient heat transfer for cooling the inner surface of a zone or compartment for condensing a gaseous liquid into liquid state.

The technology disclosed relates to an arrangement for at least one of separating and purifying a liquid and which includes at least one membrane through which a fluid can pass only when it is in the gaseous phase and where peripheral surface portions of the membrane are an integral part of or directly joined to the surface portions of the plate structure to thereby form and define a compartment configured for condensing gas into liquid.

According to aspects the technology disclosed, the membrane may be directly joined to inner surface portions of a first side of the plate to form and define a substantially sealed compartment for condensing gas into liquid and the outlet of the compartment for condensing gas into liquid may be an integral part of the structure of the plate. The structure of the plate is configured so that a membrane may be joined to more inner surface portions of a first side of the plate structure allows for more peripheral surface portions of two plates each comprising a membrane to be joined to form and define a compartment of a warm-liquid channel which encloses the two membranes.

In embodiments, the technology disclosed relates to an arrangement, or module, for at least one of separating and purifying a liquid consisting of at least one plate comprising a structure and where the arrangement further includes a liquid phobic membrane (hydrophobic membrane in the case the liquid is water) through which gaseous liquid can pass but not fluid in liquid form, wherein surface portions of the membrane are joined to surface portions of a first side of the structure of the at least one plate so that the joined membrane is substantially parallel with and is facing a relatively thin wall constituting at least some of the more central portions of said plate structure. The surface portions of the membrane are directly joined to the surface portions of the plate structure to form a compartment for condensing gas into liquid. By increasing the temperature of the liquid so that some of the ions, for example water ions in the case of using water as the liquid, evaporate which increases the partial pressure over the liquid surface causing a transport of ions to a cool inner surface of a compartment where the vapor condenses. The pressure difference between the expanding vapor and the condensing vapor creates a steady flow of vapor. The heated liquid surface is kept in place by a liquid phobic membrane (hydrophobic membrane in the case of using water as the liquid) through which the vapor travels. Typically, substantially all non-volatiles stay in the liquid because of the surface tension of the liquid, for example water. The above specific unit operation performed by the arrangement, or module, of the technology disclosed may be referred to as thermal pervaporation.

In embodiments, outer peripheral surface portions of the same first side of the structure of one plate are joined to outer peripheral surface portions of the first side of the structure of another second plate comprising a membrane to thereby form, in addition to the compartments for condensing gas into liquid, a first type of compartment of a warm-liquid channel for carrying relatively warmer liquid. The formed first type of compartment of a warm-liquid channel is then configured so that relatively warmer liquid may pass along two substantially parallel and in the warm-liquid channel opposing membranes of two separate compartments for condensing gas into liquid. By providing a relatively warm liquid flowing through the warm-liquid channel some of the ions, for example water ions in the case of using water as the liquid, evaporate which increases the partial pressure over the liquid surface causing a transport of ions to a cooler inner surface of the compartment where the vapor condenses. In various embodiments of the technology disclosed, the inner surface of the compartment may, for example, be cooled down by heat transfer through a relatively thin wall of a cooling channel in which a cooling fluid is caused to flow, a cooling sheet may be used and/or a reservoir with relatively cool liquid may be used. Even though the liquid caused to flow through the warm-liquid channel is another liquid than water, the cooling fluid flowing through the cooling channel may still be water, or may be a refrigerant caused to flow through the cooling channel. The above specific unit operation performed by the arrangement, or module, of the technology disclosed may be referred to as thermal pervaporation.

In embodiments, surface portions of the second side of the first side of the structure of one plate are joined to surface portions of the second side of the structure of another third plate different from the second plate to thereby define a second type of compartment of a cooling channel in which a cooling fluid is caused to flow. The compartment of a cooling channel and the thickness of the relatively thin wall of the respective plate is adapted for cooling of an inner surface of the respective compartment for condensing gas into liquid by heat transfer from the cooling fluid flowing through the cooling channel through the relatively thin wall constituting at least some of the more central portions of the structure of the respective plate. By increasing the temperature of the liquid so that some of the ions, for example water ions in the case of using water as the liquid, evaporate which increases the partial pressure over the liquid surface causing a transport of ions to the cooler inner surface of the compartment where the vapor condenses. As mentioned above, the inner surface of the compartment may then be cooled down by heat transfer through the relatively thin wall of the cooling channel in which a cooling fluid is cause to flow. The pressure difference between the expanding vapor and the condensing vapor thereby creates a steady flow of vapor. The heated liquid surface is kept in place by a liquid phobic membrane (hydrophobic membrane in the case of using water as the liquid) through which the vapor travels. Typically, substantially all non-volatiles stay in the liquid because of the surface tension of the liquid, for example water. The above specific unit operation performed by the arrangement, or module, of the technology disclosed may be referred to as thermal pervaporation.

In aspects and embodiments, the technology disclosed relates to an arrangement, or module, for at least one of separating and purifying a liquid consisting of at least one plate comprising a structure and where the arrangement includes a membrane through which gaseous liquid can pass but not fluid in liquid form, wherein surface portions of the membrane are joined to surface portions of a first side of the structure of the at least one plate so that the joined membrane is substantially parallel with and is facing a relatively thin wall constituting at least some of the more central portions of the plate structure, and wherein the surface portions of the membrane are directly joined to the surface portions of the plate structure to form and define a compartment configured for condensing gas into liquid.

In aspects and embodiments, the technology disclosed relates to an arrangement for at least one of separating and purifying a liquid consisting of at least one plate comprising a structure and including a cavity in a first side of the structure and where the arrangement further includes a membrane through which gaseous liquid can pass but not fluid in liquid form, wherein peripheral surface portions of the membrane are joined to surface portions surrounding the cavity in the first side of the structure so that the joined membrane is substantially parallel with and is facing a relatively thin wall constituting a substantial portion of the cavity bottom of the cavity in the first side of the plate, and wherein the peripheral surface portions of the membrane are directly joined to the surface portions surrounding the cavity in the first side of the plate structure to form a compartment configured for condensing gas into liquid.

In embodiments, the membrane is joined to substantially planar surface portions surrounding the cavity in the first side of the plate. In embodiments, the plate further comprises at least one outlet that forms an integral part of the structure of the plate and that is configured to define the outlet(s) for conveying fluid away from the compartment for condensing gas into liquid. The opening of the outlet may then be in the side wall of the structure of the plate, where the normal axis of the plane of the side wall is typically substantially perpendicular to both the normal axis of the plane of the first side of the plate and the normal axis of the plane of the second side of the plate.

In aspects and embodiments, the technology disclosed relates to an arrangement for at least one of separating and purifying a liquid consisting of at least one plate comprising a structure with at least one depression in a first side of the structure and where the arrangement further includes a membrane through which gaseous liquid can pass but not fluid in liquid form, wherein peripheral surface portions of the membrane are joined to surface portions surrounding the at least one depression in the first side of the structure so that the joined membrane is substantially parallel with and is facing a relatively thin wall constituting at least a substantial portion of the bottom wall of the depression in the first side of the plate structure, and wherein the peripheral surface portions of the membrane are directly joined to the surface portions surrounding the at least one depression in the first side of the plate structure to form a compartment configured for condensing gas into liquid.

In embodiments, the membrane is joined to substantially planar surface portions surrounding the at least one depression. In embodiments, the plate further comprises at least one outlet that forms an integral part of the structure of the plate and that is configured to define the outlet(s) for conveying fluid away from the compartment for condensing gas into liquid. The opening of the outlet may then be in a side wall of the structure of the plate, where the normal axis of the plane of the side wall is substantially perpendicular to both the normal axis of the plane of the first side of the plate and the normal axis of the plane of the second side of the plate.

In aspects and embodiments, the technology disclosed relates to an arrangement, or module, for at least one of separating and purifying a liquid consisting of at least one plate comprising a structure and where the arrangement includes a membrane through which gaseous liquid can pass through but not fluid in liquid form, wherein peripheral surface portions of the membrane are joined to surface portions of a first side of the structure of the at least one plate so that the joined membrane is substantially parallel with and is facing a relatively thin wall constituting at least some of the more central portions of the plate structure, and wherein the peripheral surface portions of the membrane are directly joined to the surface portions of the plate structure to form a compartment. The compartment formed by the joining of the membrane to the first side of the structure of the plate is configured for condensing gaseous liquid passing through the joined membrane into liquid. In embodiments, the plate comprises at least one outlet that forms an integral part of the structure of the plate and that is configured to define the outlet(s) for conveying fluid away from the compartment for condensing gas into liquid.

In aspects and embodiments, the technology disclosed relates to an arrangement, or module, for at least one of separating and purifying a liquid consisting of at least one plate comprising a structure and where the arrangement includes a membrane through which gaseous liquid can pass through but not fluid in liquid form, wherein surface portions of the membrane are joined to surface portions of a first side of the structure of the at least one plate so that the joined membrane is substantially parallel with and is facing a relatively thin wall constituting at least some of the more central portions of the plate structure, and wherein the surface portions of the membrane are directly joined in a closed joining line to thereby form and define a compartment. The compartment formed by the joining of the membrane to the first side of the structure of the plate is configured for condensing gaseous liquid passing through the joined membrane into liquid. In embodiments, the plate comprises at least one outlet that forms an integral part of the structure of the plate and that is configured to define the outlet(s) for conveying fluid away from the compartment for condensing gas into liquid.

In aspects and embodiments, the technology disclosed relates to an arrangement, or module, for at least one of separating and purifying a liquid consisting of at least one plate comprising a structure and where the arrangement includes a membrane through which gaseous liquid can pass through but not fluid in liquid form, wherein surface portions of the membrane are joined to surface portions of a first side of the structure of the at least one plate so that the joined membrane is substantially parallel with and is facing a relatively thin wall constituting at least some of the more central portions of the plate structure, and wherein the surface portions of the membrane are directly joined in a closed joining line to thereby form and define a sealed compartment between the relatively thin wall and the membrane. The substantially sealed compartment formed by the joining of the membrane is configured for condensing gaseous liquid passing through the joined membrane into liquid. In embodiments, the plate comprises at least one outlet that forms an integral part of the structure of the plate and that is configured to define the outlet(s) for conveying fluid away from the sealed compartment for condensing gas into liquid.

In aspects and embodiments, the technology disclosed relates to an arrangement comprising two plates which are joined to each other on the outer peripheral surface portions of respective same first side as the membrane is joined to (or an integral part of) the respective plate structure. The joining of the two plates forms and defines a compartment of a warm-liquid channel including the two membranes. Typically, the two membranes each constitutes a substantial portion of the respective of the two walls of the compartment for carrying relatively warmer liquid. The compartment of the warm-liquid channel is formed and defined by joining of outer peripheral surface portions of the two plates on the same first side of the respective plate as the respective membrane is already joined to (or an integral part of). This joining of the plates on the same side of the respective plate as suggested by the technology disclosed allows for the relatively warmer liquid flowing through the warm-liquid compartment to be passing along both two substantially parallel and opposing membranes, where each membrane is constituting substantial portions of the wall of the respective compartment for condensing gas into liquid.

According to embodiments of the technology disclosed, the joining line formed and defined by the direct joining (without any gaskets) of the outer peripheral surface portions of the first side of the respective plate forms and defines at least one inlet and at least one outlet of the compartment of the warm-liquid channel. The joining line along the outer peripheral surface portions of the first side of the respective of the two plates may then be a closed joining line except for the at least one inlet and the at least one outlet of the formed and defined compartment of the warm-liquid channel.

In aspects and embodiments, the technology disclosed relates to an arrangement comprising two plates which are joined together to form and define a compartment of a cooling channel configured to provide efficient heat transfer for cooling of two separate inner surfaces of two separate compartments for condensing a gaseous liquid into liquid state. Outer surface portions on the other second side from the side the membrane is already joined to the plate structure of one plate may then be joined to corresponding outer surface portions on the same second side of another plate to thereby form and define a second type of compartment of a cooling channel for carrying cooling fluid, wherein the compartment of a cooling channel is configured for cooling of an inner surface of the respective compartment for condensing gas into liquid by heat transfer from the cooling fluid through the relatively thin wall constituting at least some of the more central portions of the structure of the respective plate.

According to embodiments of the technology disclosed, the joining line formed and defined by the direct joining (without any gaskets) of the outer peripheral surface portions of the second side different from the first side the respective membrane is joined to forms and defines at least one inlet and at least one outlet of the compartment of the cooling channel. The joining line along the outer peripheral surface portions of the second side of the respective of the two plates may then be a closed joining line except for the at least one inlet and the at least one outlet of the formed and defined compartment of the cooling channel.

In embodiments, the technology disclosed relates to an arrangement, or module, for at least one of separating and purifying a liquid which is built-up by stacking plates that are directly joined to each other without using any gaskets and where the joining of every other pair of plates in the stack forms and define a compartment of a warm-liquid channel and where the joining of every other pair of plates in the stack forms and define a compartment of a cooling channel.

In embodiments of the technology disclosed, the structure of the respective of two plates in the stack that are joined together may then be configured so that the edge structures of two opposing edges of a first side of the respective plate, when joined together with corresponding edges of a first side of another plate, form and define at least one inlet and at least one outlet of a compartment of a warm-liquid channel and every other two plates in the stack that are joined together may then be configured so that the edge structures of two opposing edges of a second side of the respective plate, when joined together with corresponding edges of a second side of another plate, form and define at least one inlet and at least one outlet of a compartment of a cooling channel. Hence, according to this example embodiments and when two first sides of two plates then are joined together, at least one inlet and at least one outlet of a compartment of a warm-liquid channel are formed and when two second sides of two plates are joined together at least one inlet and at least one outlet of a compartment of a cooling are formed. The edge structure of two of the edges of each plate may then each comprise at least one incision, e.g. a semicircular opening, that defines half of the opening of either an inlet or an outlet when two plates are joined together. In certain embodiments, the module is built-up of substantially identical plates by turning every other plate in the stack 180 degrees around its longitudinal center line.

In embodiments, the structure of an example embodiment of a plate may comprise at least one incision forming part of the edge structure at a first edge of the plate and at least one incision forming part of the edge opposite to the first edge. When two first sides of two plates of this example embodiment of a plate are joined together at least one inlet and at least one outlet of a compartment of a warm-liquid channel are defined by joining two plates together in that the two incisions of one plate meet their respective incision to form an opening defining the inlet and outlet, respectively. When two second sides of two plates are joined together at least one inlet and at least one outlet of a compartment of a cooling channel are defined by joining the plates together in that at least two incisions of one plate meet their respective incisions to form openings defining the inlet(s) to the compartment of the warm-liquid channel and the outlet(s) from the compartment of the warm-liquid channel, respectively.

In aspects and embodiments, the technology disclosed relates to a module for at least one of separating and purifying a liquid comprising a plate having a structure and including a membrane through which gaseous liquid can pass through but not fluid in liquid form, wherein outer peripheral surface portions of the membrane is joined to the structure of the plate by a closed joining line along surface portions of the first side of the structure so that the joined membrane is substantially parallel with and is facing a relatively thin wall constituting at least some of the more central portions of the plate structure, and wherein the distance between the relatively thin wall and the membrane defines the air gap of a compartment for condensing gas into liquid and the module may be an Air Gap Membrane Distillation (AGMD) module.

In aspects and embodiments, the technology disclosed relates to a module for at least one of separating and purifying a liquid comprising a plurality of plates joined to each other where each of the plates have a structure and includes a membrane through which gaseous liquid can pass through but not fluid in liquid form. The outer peripheral surface portions of the membrane of each of the plates is joined to the structure of the respective plate by a closed joining line along surface portions of the first side of the structure so that the joined membrane is substantially parallel with and is facing a relatively thin wall constituting at least some of the more central portions of the plate structure of the respective plate. The distance between the relatively thin wall and the membrane defines the air gap of the respective compartment for condensing gas into liquid, e.g. a compartment for Air Gap Membrane Distillation (AGMD). The above arrangement and plate of the technology disclosed is thereby designed to reduce the risk of leakage and provide protection from external particles, substances and other contaminants entering the arrangement, yet providing a structure for efficient heat transfer for cooling the inner surface of a zone or compartment for condensing a gaseous liquid into liquid state.

The intelligent design of the structure of plate according to embodiments of the technology disclosed enables that another plate may be joined to the outer peripheral surface portions on the same first side of the plate structure as the membrane is joined to (or is an integral part of) to thereby form a compartment for a warm-liquid channel and a compartment for condensing gas into liquid, respectively. This makes the module according to the technology disclosed more compact, less complex and the cost for manufacturing the module is lower compared to alternative prior art methods for manufacturing an Air Gap Membrane Distillation (AGMD) module where various and different types of frames and separate cooling sheets are stacked after each other in separate joining steps.

In prior art AGMD modules, the membrane is typically joined to an open frame structure and the open frame structure with the frame is sequentially joined to another frame to define a compartment, e.g. an ultrapure water compartment for purifying water. The intelligent design of the structure of the plate according to the technology disclosed, which is configured so that two frames may be joined to each other on the same first side of the respective plate structure as the respective membrane is joined to, also enables that the at least one outlet of the compartment for condensing gas into liquid may be an injection moulded and/or 3D printed integral part of the plate structure to which the membrane is already joined to, thereby reducing the risk of leakage and particles and other contaminants entering the compartment for condensing gas into liquid and/or the container for collecting purified and/or separated liquid.

According to embodiments of the technology disclosed, plates with the same type of structure and comprising a membrane may be joined and stacked together to form both the compartment of the warm-liquid channel and the compartment of the cooling channel, which enables a significantly lower total manufacturing cost compared to alternative prior art modules which are manufactured by stacking different types of frames and separate cooling sheets after each other and where the membrane is typically joined in a separate joining step to an open frame which is a different frame from the other frames/plates in the module stack.

In aspects, the technology disclosed relates to a plate and an arrangement for at least one of separating and purifying a liquid.

In aspects, the technology disclosed relates to an arrangement and plate for at least one of purifying a liquid and separating liquid and/or at least one of particles and other substances from a liquid mixture.

In aspects, the arrangement comprises at least one plate having a structure. The arrangement according to the technology disclosed further includes at least one membrane through which gaseous liquid can pass through but not fluid in liquid form. In further aspects, the arrangement comprises at least one plate and peripheral surface portions of a membrane are joined to outer surface portions of a first side of the structure of the at least one plate so that the joined membrane is substantially parallel with and is facing a relatively thin wall constituting at least some of the more central portions of the plate structure.

In aspects and embodiments of the technology disclosed, the distance along a substantially normal axis to the relatively thin wall to the membrane defines the air gap of the compartment for condensing gas into liquid.

In aspects and embodiments, the two plates that are joined to form and define the compartment of the warm-liquid channel are joined together on the same side of the respective plate structure as the side to which the respective membrane is joined to form and define the respective compartment for condensing gas into liquid.

In aspects and embodiments of the technology disclosed, the distance along a substantially normal axis to the relatively thin wall to a membrane that is joined to the same side of the structure that includes the surface area of the relatively thin wall inside the compartment for condensing gas into liquid defines the air gap of the compartment for condensing gas into liquid.

In aspects and embodiments of the technology disclosed, the distance between the two membranes along a substantially normal axis to the membranes essentially defines the gap of the compartment of the warm-liquid channel.

In aspects and embodiments of the technology disclosed, outer peripheral surface portions of two plates are joined to each other on the same first side of the respective plate structure as the respective membrane is joined to the plate structure and the distance between the two membranes along a substantially normal axis to the membranes essentially defines the gap of the compartment of the warm-liquid channel.

In aspects and embodiments, more peripheral surface portions of the membrane are directly joined to the outer surface portions of the structure of the plate to thereby form and define a compartment for condensing gas into liquid. In these embodiments, the membrane may be directly joined to the plate structure by welding, e.g. by laser welding or ultrasonic welding. However, welding is one possible type of joining process for directly joining the plates together without using gaskets; other examples include riveting, soldering, adhesive, brazing, coupling, fastening and press fit.

In further aspects and embodiments, the structure of the plate comprises at least one outlet as an integral part of the structure and peripheral surface portions of the membrane are directly joined to the outer surface portions of the plate structure comprising the at least one outlet.

In embodiments, the structure of the at least one plate comprises at least one outlet for conveying fluid away from the compartment for condensing gas into liquid. The at least one outlet may then constitute an integral part of the plate structure to thereby minimize the risk of leakage and significantly reduce the risk of external particles and other contaminants entering the at least one of separated and purified liquid contained in the compartment for condensing gas into liquid.

In other aspects and embodiments, the technology disclosed relates to a plate comprising a structure and including an integrated membrane through which gaseous liquid can pass through but not fluid in liquid form. According to these embodiments of the technology disclosed, the membrane is an integral part of the structure in that the membrane is substantially parallel with and is facing a relatively thin wall constituting at least some of the more central portions of the plate structure. The area between the relatively thin wall and the membrane is formed to define a substantially sealed compartment configured for condensing gas into liquid. In embodiments, the plate comprises at least one outlet constituting an integral part of the structure of the plate. In certain embodiments, the membrane is at least one of injection moulded and 3D printed to be an integral part of the structure.

According to aspects and embodiments of the technology disclosed, two plates are directly joined to each other to form a compartment of a warm-liquid channel, for example a warm-water channel, without any intermediate gaskets, thereby reducing or eliminating the risk of leakage and contamination. The plates may then be directly joined to form the compartment for warm-liquid channel, for example warm-water channel, by welding the plates together, e.g. by laser welding or ultrasonic welding. However, welding is one possible type of joining process for directly joining the plates together; other examples include riveting, soldering, adhesive, brazing, coupling, fastening and press fit.

According to aspects and embodiments of the technology disclosed, the two plates are directly joined to each other on the same first side of the plate structure as the respective membrane is joined to the plate structure. In embodiments, the outer surface portions of a first side of the structure of a first plate that has a membrane joined to its structure are directly joined to outer surface portions of the first side of the structure of another plate that has a membrane joined to its structure to thereby form, in addition to the compartments for condensing gas into liquid, a compartment of a warm-liquid channel for carrying relatively warmer liquid. The compartment of a warm-liquid channel formed by the direct joining of the plates without any intermediate gaskets is configured so that relatively warmer liquid may pass along the substantially parallel and inside the formed compartment of the warm-liquid channel opposing membranes each constituting the wall of a separate compartments for condensing gas into liquid.

According to aspects and embodiments of the technology disclosed, the two plates are joined to each other to define at least one inlet and at least one outlet for the compartment of the warm-liquid channel.

According to aspects and embodiments of the technology disclosed, two plates are directly joined to each other to form a compartment of a cooling channel without any intermediate gaskets or cooling sheets, thereby reducing or eliminating the risk of leakage and contamination. The plates may then be directly joined to form the compartment for a cooling channel by welding the plates together, e.g. by laser welding or ultrasonic welding. However, welding is one possible type of joining process for directly joining the plates together; other examples include riveting, soldering, adhesive, brazing, coupling, fastening and press fit.

In embodiments, outer surface portions of a second side of a first plate having a membrane joined to its structure are joined to outer surface portions of the second side of the structure of another plate having a membrane joined to its structure to thereby form a second type of compartment of a cooling channel for carrying cooling fluid, without any intermediate gaskets or separate cooling sheets. The formed compartment of the cooling channel may then be configured for cooling of an inner surface of the respective compartment for condensing gas into liquid by heat transfer from the cooling fluid of the cooling channel through a relatively thin wall constituting at least some of the more central portions of the structure of the respective plate. In embodiments, the two plates are directly joined to each other to form and define at least one inlet and at least one outlet for the compartment of the cooling channel, without any intermediate gaskets.

In aspects and embodiments, the arrangement of the technology disclosed comprises two different types of compartments of a cooling channel and a warm-liquid channel. The respective type of compartment may then comprise at least one inlet and at least one outlet and each type of compartment is formed and defined by the respective directly joined surface portions of two plates having a membrane joined to their respective surfaces so that each unit for condensing gas into liquid is directly formed and defined by the joined plates without any intermediate gaskets for the inlets and outlets for the respective compartment, thereby reducing or eliminating the risk of leakage and contamination from inside and outside the arrangement.

In aspects and embodiments of the technology disclosed, the structure of the at least one plate is configured so that the thickness of at least some of the more central portions of the plate structure of the at least one plate forms and defines a relatively thin first wall adapted for transferring heat from the cooling fluid of a cooling channel through the thin wall to cool down an inner surface of the compartment for condensing gas into liquid.

In certain embodiments, the thickness of the at least some of the more central portions of the plate structure defining a relatively thin first wall of the at least one plate is less than 2 mm, wherein the relatively thin wall is thereby adapted for efficient heat transfer for cooling of the inner surface of the compartment for condensing gas into liquid.

In certain embodiments, the thickness of the at least some of the more central portions of the plate structure defining a relatively thin first wall of the at least one plate is less than 1 mm, wherein the relatively thin wall is thereby adapted for efficient heat transfer for cooling of the inner surface of the compartment for condensing gas into liquid.

In certain embodiments, the structure of the at least one plate is at least partly made of a of a highly non-reactive material.

In certain embodiments, the structure of the plate is at least partly made of a polymer material.

In certain embodiments, the structure of the plate is made of a polymer material.

In certain embodiments, the at least some of the more central portions of the plate structure defining the relatively thin first wall of the at least one plate is at least partly made of a at least partly different material from the material of the rest of the plate structure.

In aspects and embodiments, the technology disclosed relates to an arrangement comprising two plates which are joined to each other on the respective same side as the membrane is joined to the respective plate structure and where the joining of the two plates forms and define a compartment of a warm-liquid channel including the two membranes constituting a substantial portion of the two walls of the compartment for carrying relatively warmer liquid. The compartment of the warm-liquid channel is formed and defined by the joining of peripheral portions of the two plates on the same first side of the respective plate as the respective membrane is already joined to or an integral part of. This joining of the plates on the same side of the respective plate as the membranes are joined provides for a module that is compact and easy to manufacture by. By joining peripheral portions of the two plates together to enclose the two membranes as an interior part/wall of the formed and defined compartment of the warm-liquid channel, the relatively warmer liquid flowing through the compartment of the warm-liquid channel is allowed to be passing along both two substantially parallel and opposing membranes, where each membrane is typically constituting substantial portions of one of the walls and inner surface of the respective compartment for condensing gas into liquid.

In aspects and embodiments, the technology disclosed relates to an arrangement comprising two plates which are joined together on a second side of the respective plate to form and define a compartment of a cooling channel which is configured to provide efficient heat transfer for cooling of two separate inner surfaces of two separate compartments for condensing gas into liquid, i.e. a gaseous liquid into liquid state.

In aspects, the technology disclosed relates to an air gap membrane distillation (AGMD) arrangement that allows for a first fluid or liquid to pass close to a second cooling fluid, while not mixing with it, which arrangement comprises a plurality of plates. A membrane through which the first fluid can pass only when it is in the gaseous phase. Temperature differences cause the first fluid to vaporise, to pass through the membrane and to condense onto a wall, which is colder than the first fluid that is to be purified. The surface tension of the first fluid ensures that the fluid in liquid form cannot pass through the membrane. The arrangement comprises at least one plate having a structure and at least one membrane through which gaseous liquid can pass through but not fluid in liquid form.

In aspects, the arrangement for at least one of separating and purifying a liquid comprises a plurality of joined plates, where each of the plates is comprising a membrane joined to the plate structure of the respective plate to thereby form a compartment for condensing gas into liquid including at least one outlet for fluid away from the compartment for condensing gas into liquid.

In aspects, peripheral surface portions of a membrane are joined to outer surface portions of a first side of the structure of a plate of the arrangement so that the joined membrane is substantially parallel with and is facing a relatively thin wall constituting at least some of the more central portions of the plate structure. The peripheral surface portions of the membrane are directly joined to outer surface portions of the structure of the plate to thereby form and define a compartment for condensing gas into liquid.

The structure of the plate may be configured so that the thickness of at least some of the more central portions of the plate structure of the plate forms and defines a relatively thin first wall adapted for transferring heat from the cooling fluid of a cooling channel through the thin wall to cool down an inner surface of the compartment for condensing gas into liquid. In aspects and embodiments, the structure of the plate comprises at least one outlet as an integral part of the structure and peripheral surface portions of the membrane are directly joined to the outer surface portions of the plate structure comprising the at least one outlet. The structure of the plate may then comprise at least one outlet for conveying fluid away from the compartment for condensing gas into liquid. The at least one outlet may constitute an integral part of the plate structure to thereby minimize the risk of leakage but also the risk of external particles and other contaminants entering the arrangement and mixing with the liquid contained in the compartment for condensing gas into liquid.

Two plates that each are joined to a respective membrane may then be directly joined to each other to form a compartment of a warm-liquid channel, for example a warm-water channel, without any intermediate gaskets, thereby reducing or eliminating the risk of leakage and contamination. In embodiments, the outer surface portions of a first side of the structure of a first plate that has a membrane joined to its structure are directly joined to outer surface portions of the first side of the structure of another plate that has a membrane joined to its structure to thereby form a compartment of a warm-liquid channel for carrying relatively warmer liquid.

The compartment of a warm-liquid channel formed by the direct joining of the plates may then be configured so that relatively warmer liquid flowing through the warm-liquid channel can pass along two substantially parallel and inside the formed compartment opposing membranes. Each membrane then constitutes the wall of a separate compartments for condensing gas into liquid. In embodiments, the two plates are joined to each other to also form at least one inlet and at least one outlet for the compartment of the warm-liquid channel.

According to aspects and embodiments of the technology disclosed, two plates are directly joined to each other to form a compartment of a cooling channel without any intermediate gaskets or cooling sheets, thereby reducing the risk of leakage and contamination. In embodiments, outer surface portions of a second side of a first plate having a membrane joined to its structure are joined to outer surface portions of the second side of the structure of another plate having a membrane joined to its structure to thereby form a second type of compartment of a cooling channel for carrying cooling fluid. The two plates may then be joined to each other without any intermediate gaskets or separate cooling sheets.

The formed compartment of the cooling channel may be configured for cooling of an inner surface of the respective compartment for condensing gas into liquid by heat transfer from the cooling fluid of the cooling channel through a relatively thin wall constituting at least some of the more central portions of the structure of the respective plate. In embodiments, the two plates are directly joined to each other to form and define at least one inlet and at least one outlet for the compartment of the cooling channel, without any intermediate gaskets.

In aspects and embodiments of the technology disclosed, the arrangement of the technology disclosed comprises two different types of compartments of a cooling channel and a warm-liquid channel. Each type of compartment is then formed and defined by the respective directly joined surface portions of two plates having a membrane joined to their respective surface. The respective type of compartment may then comprise at least one inlet and at least one outlet and each type of compartment may be formed and defined by the respective directly joined surface portions of two plates having a membrane joined to their respective surfaces so that each unit for condensing gas into liquid is directly formed and defined by the joined plates without any intermediate gaskets for the inlets and outlets for the respective compartment, thereby reducing or eliminating the risk of leakage and contamination from inside and outside the arrangement.

In certain embodiments, the at least some of the more central portions of the plate structure forming and defining the relatively thin first wall of the at least one plate is at least partly made of a metallic material.

In certain embodiments, the relatively thin first wall of the at least one plate is at least partly defined by a sheet at least partly made of a different material from the polymer material that the rest of the plate structure is made of. The sheet may be joined to the plate structure or is an integral part of the plate structure. In embodiments, a sheet or applied thin layer, e.g. by coating of a non-metallic film, at least partly made of a metallic material at least partly forms and defines the relatively thin first wall of the plate. The sheet or applied thin layer, e.g. a coated film, may then be at least partly made of a metallic material that constitutes an integral part of the plate structure.

In embodiments, the arrangement further comprises a collection container joined to the plate structure and connected to the at least one outlet for conveying fluid away from the respective compartment for condensing gas into liquid. The collection container may be directly joined to the plate structure without any intermediate gaskets and adapted for collecting fluid from the compartment for condensing gas into liquid.

The collection container may be directly joined to the plate structure without any intermediate gaskets for connecting the at least one outlet for conveying fluid away from the respective compartment for condensing gas into liquid to the collection container, thereby reducing or eliminating the risk of leakage and contamination.

In aspects and embodiments, two different types of compartments of a cooling channel and a warm-liquid channel each comprising the respective at least one inlet and at least one outlet of each compartment are each formed and defined by two plates that are joined together so that each unit for condensing gas into liquid is directly formed and defined by the sequential joining of two plates having a membrane and without any intermediate gaskets for the inlets and outlets for the respective compartment, thereby reducing or eliminating the risk of leakage and contamination from inside and outside the arrangement.

In embodiments, the structure of at least one of the at least one plate of the arrangement according to the technology disclosed is at least partly made of a of a highly non-reactive material. In embodiments, the structure of at least one of the at least one plate of the arrangement according to the technology disclosed is at least partly made of a polymer material. The structure of the at least one plate of the arrangement may be made of a polymer material, e.g. a fluoropolymer material.

In embodiments, at least the surface structure of the respective membrane inside the compartment for condensing gas into liquid and facing the relatively thin wall is made of PolyTetraFluoroEthylene (PTFE).

In embodiments, the height of at least one plate of the at least one plate is between 18 and 25 centimeters.

In embodiments, the width of at least one plate of the at least one plate is between 18 and 25 centimeters.

In embodiments, the height of at least one of the at least one membrane of the at least one plate is between 15 and 22 centimeters.

In embodiments, the width of the at least one membrane of the at least one plate is between 15 and 22 centimeters.

According to aspects of the technology disclosed, the technology disclosed relates to an arrangement for at least one of separating and purifying a liquid including a plurality of plates, where outer peripheral portions each of the plates are directly joined to another plate to form a compartment of a warm-liquid channel including at least one inlet and at least one outlet, and where the at least one inlet and the at least one outlet of the compartment are formed and defined by the joining of two plates and each of the two plates comprises a membrane through which liquid continuously flowing through the compartment of the warm-liquid channel can pass only when it is in the gaseous phase. The compartment may then be part of a closed loop recirculating warm-liquid channel and system, comprising the compartment for the warm-liquid channel which includes the at least one inlet to the compartment and the at least one outlet from the compartment.

According to aspects and embodiments of the technology disclosed, the technology disclosed relates to an arrangement for at least one of separating and purifying a liquid including a plurality of plates, where each of the plates is directly joined to another plate to form a compartment of a cooling channel including at least one inlet and at least one outlet, and where the at least one inlet and the at least one outlet of the compartment are formed and defined by the joining of two plates. The compartment may then be part of a closed loop recirculating cooling channel and system, comprising the compartment including the at least one inlet to the compartment and the at least one outlet from the compartment.

The plates that are joined together to form the compartment of a cooling channel may each comprise a membrane, which may be an integral part of the plate structure or joined to the plate structure. The membrane together with the plate structure forms a compartment for condensing gas into liquid. In aspects, the compartment of the cooling channel is adapted for use with a continuous stream of cooling fluid providing a cooling effect on the inner surfaces of the respective compartment for condensing gas into liquid of the respective plate that are joined together. In embodiments, each of the plates comprises a sub-structure of the plate structure in the form of a relatively thin wall which is parallel with and opposite to the membrane.

According to aspects of the technology disclosed, the technology disclosed relates to an arrangement for at least one of separating and purifying a liquid including a plurality of plates, where outer peripheral portions each of the plates are directly joined to another plate to form a compartment of a warm-liquid channel including at least one inlet and at least one outlet. The at least one inlet and the at least one outlet of the compartment may then be formed and defined by the joining of two plates. This type of compartment may then be adapted for carrying a stream of a relatively warmer fluid or liquid membrane which can pass through a membrane of the respective plate only when it is in the gaseous phase. Temperature differences cause the first fluid to vaporise, to pass through the membrane of the respective plate and to condense onto a wall of a compartment for condensing gas into liquid, where a second fluid flowing outside a relatively thin wall of the compartment for condensing gas into liquid is colder than the first fluid or liquid that is to be separated and/or purified.

In embodiments, the relatively thin wall is at least partly made of a polymer material and the thickness of the relatively thin wall is less than 2 mm to be adapted for efficient heat transfer through the relatively thin wall for cooling of the inner surface of the compartment for condensing gas into liquid and thereby provide for efficient condensation of liquid in gaseous form on the inner surfaces of the compartment for condensing gas into liquid.

In embodiments, the relatively thin wall is at least partly made of a polymer material and the thickness of the relatively thin wall is less than 1 mm to be adapted for efficient heat transfer through the relatively thin wall for cooling of the inner surface of the compartment for condensing gas into liquid and thereby provide for efficient condensation of liquid in gaseous form on the inner surfaces of the compartment for condensing gas into liquid.

In certain embodiments, the relatively thin wall of the respective plate is at least partly made of a metallic material, thereby further improving the heat transfer through the wall to cool the inner surfaces of the compartment for condensing gas into liquid of the respective plate.

In certain embodiments, a metallic sheet which is less than 0.5 mm thick may be joined to a relatively thin wall of the plate structure made of a polymer material and both the metallic sheet and the membrane may then be made of a separate material from the rest of the plate structure.

In certain embodiments, the plate structure may be injection moulded to form both sub-structures made of polymer material and sub-structures at least partly made of metallic material, e.g. the relatively thin wall may be at least partly made of a metallic material and both the relatively thin wall and the membrane may be made of a separate material from the rest of the plate structure.

According to aspects and embodiments of the technology disclosed, the technology disclosed relates to an arrangement for at least one of separating and purifying a liquid including a stack of plates, where each of the plates is directly joined to at least one other plate in the stack to form a compartment including at least one inlet and at least one outlet which are formed and defined by the joining of the plates. Each other joining of two plates in the stack may then form and define a compartment of a warm-liquid channel and each other joining of two plates may form and define a compartment of a cooling channel.

In embodiments, the technology disclosed relates to an arrangement for at least one of separating and purifying a liquid including a plurality of plates, where each of the plates comprises a structure and a membrane through which the liquid in gaseous form can pass but not fluid in liquid form. The structure of the respective plate may further comprise, as an integral part of the plate structure, at least one outlet for conveying fluid away from the compartment for condensing gas into liquid.

In embodiments, the technology disclosed relates to an arrangement for at least one of separating and purifying a liquid including a plurality of plates, each of the plates comprises a structure and a membrane through which the liquid in gaseous form can pass but not fluid in liquid form, wherein each of the membranes is joined to, or is an integral part of, a first side of the structure of the respective plate to form a respective compartment between the membrane and surface portions of the respective structure for condensing gas into liquid, and wherein the structure of the respective plate includes at least one outlet for conveying fluid away from the compartment for condensing gas into liquid.

In embodiments, the technology disclosed relates to an arrangement for at least one of separating and purifying a liquid including a plurality of plates, each of the plates comprises a structure and a membrane through which the liquid in gaseous form can pass but not fluid in liquid form, wherein each of the membranes is joined to, or is an integral part of, a first side of the structure of the respective plate to form a respective compartment between the membrane and surface portions of the respective structure for condensing gas into liquid, and wherein the structure of the respective plate further comprises, as an integral part of the plate structure, at least one outlet for conveying fluid away from the compartment for condensing gas into liquid.

In embodiments, the arrangement comprises at least two plates where portions of the first side of the structure of a first plate are joined to portions of the first side of the structure of a second plate to form a compartment of a warm-liquid channel including at least one inlet and at least one outlet, and wherein the warm-liquid channel is configured for continuously carrying relatively warmer liquid along the membrane of the respective plate so that liquid in gaseous from may pass through the respective membrane and be condensed on the inner surface of the respective compartment for condensing gas into liquid.

In embodiments, the at least one outlet of the compartment for condensing gas into liquid forms an integral part of the structure of the respective plate, and wherein each of the membranes is at least one of welded to and injection moulded to the first side of the structure of the respective plate to form the compartment for condensing gas into liquid.

In embodiments, at least a substantial portion of the structure of each plate arranged opposite the membrane and having surface portions facing the membrane inside the compartment for condensing gas into liquid form a relatively thin wall adapted for efficient heat transfer through the relatively thin wall for cooling of the inner surface of the compartment for condensing gas into liquid.

In embodiments, a cooling channel for continuously carrying relatively colder fluid is formed outside the compartment for condensing gas into liquid by joining portions of the second side of a plate to the second side of a third plate different from the second plate.

In embodiments, the thickness of the substantial portions forming the relatively thin wall is adapted for cooling of the inner surface of the compartment for condensing gas into liquid by efficient heat transfer from the relatively colder fluid passing along the other side of the relatively thin wall through the cooling channel.

In embodiments, substantial portions of the structure are defined by more than 50% of the corresponding total structure area inside the compartment for condensing gas into liquid having surface portions facing the membrane.

In embodiments, the arrangement is defined by directly joining plates together so that portions of a second side of the structure of a first plate is joined to portions of the second side of the structure of a third plate to thereby form the compartment of a cooling channel for continuously carrying relatively colder fluid adapted for providing a cooling effect by transferring heat through the relatively thin wall of the respective structure, thereby cooling the inner surface of the compartment for condensing gas into liquid opposite to and facing the membrane of the compartment for condensing gas into liquid of both the first and the second plate. In certain embodiments, the arrangement is defined by directly joining portions of a second side of the structure of the first plate to portions of the second side of the structure of a third plate further to thereby form at least one inlet and at least one outlet to the compartment of the cooling channel for continuously carrying relatively colder fluid. The relatively colder fluid may be in liquid form or may be a gas.

In embodiments, the arrangement is defined by welding the plates together so that outer surface portions of the second side of the structure of a first plate are welded to outer surface portions of the second side of the structure of a second plate to thereby form and define a compartment for a cooling channel used for carrying relatively colder fluid for cooling of both the first side of the structure of the first plate and the first side of the structure of the second plate so that the liquid in gaseous form passing through the respective membrane is condensed into liquid on both the first side and inner surface of the compartment for condensing gas into liquid of the first plate and on the first side and inner surface compartment for condensing gas into liquid of the second plate.

In certain embodiments, the at least one inlet and at least one outlet of the sealed compartment of the cooling channel are also formed by the welding of the outer portions of the second side of the structure of a first plate to outer portions of the second side of the structure of a second plate, thereby forming a closed section of a cooling channel, e.g. a closed loop recirculating cooling channel and system, comprising the closed compartment, the at least one inlet to the closed compartment and the at least one outlet from the compartment.

In embodiments, the arrangement may be further formed and defined by joining portions of the first side of the structure of the first plate to portions of the first side of the structure of a third plate different from the second plate to form at least one inlet and at least one outlet of a compartment of a warm-liquid channel for continuously carrying relatively warmer liquid both along the surface of the membrane of the first plate and along the surface of the membrane of the third plate so that gaseous liquid may pass through the respective membrane and be condensed on the cooled down inner surface of the respective compartment for condensing gas into liquid.

In embodiments, at least one inlet and at least one outlet of the compartment of the warm-liquid channel are also formed and defined by the joining of the outer portions of the first side of the structure of the first plate to outer portions of the first side of the structure of the third plate, thereby forming an essentially sealed compartment or chamber for a warm-liquid channel comprising the sealed compartment, the at least one inlet to the sealed compartment and the at least one outlet from the sealed compartment.

In embodiments, the warm-liquid channel is part of a closed loop system for recirculating portions of the relatively warmer liquid passing along a membrane, and wherein the at least one inlet and at least one outlet of the compartment of the warm-liquid channel does/do not comprise any gaskets, thereby minimizing the risk of leakage and removing or significantly reducing the risk of particles entering the warm-liquid channel.

In embodiments, the arrangement comprises a closed loop sub-system for recirculating relatively cooling fluid, e.g. cooling liquid or cooling fluid, comprising the compartment for a cooling channel and a closed loop sub-system for recirculating relatively warmer liquid comprising the compartment for a warm-liquid channel.

In embodiments, the arrangement is further configured to maintain the temperature of the relatively warmer liquid passing through the warm-liquid channel to be at least more than about 5 degrees warmer than the relatively colder liquid passing through the cooling channel.

In certain embodiments, the arrangement is further configured to maintain the temperature of the relatively warmer liquid passing through the warm-liquid channel to be at least more than about 15 degrees warmer than the relatively colder fluid passing through the cooling channel.

In certain embodiments, the arrangement is further configured to maintain the temperature of the relatively warmer liquid passing through the warm-liquid channel to be at least more than about 25 degrees warmer than the relatively colder fluid passing through the cooling channel.

In certain embodiments, the arrangement is further configured to maintain the temperature of the relatively warmer liquid passing through the warm-liquid channel to be at least more than about 35 degrees warmer than the relatively colder fluid passing through the cooling channel.

In certain embodiments, the arrangement is further configured to maintain the temperature of the relatively warmer liquid passing through the warm-liquid channel to be above 20 degrees Celsius.

In certain embodiments, the arrangement is further configured to maintain the temperature of the relatively warmer liquid passing through the warm-liquid channel to be above 40 degrees Celsius.

In certain embodiments, the arrangement is further configured to maintain the temperature of the relatively warmer liquid passing through the warm-liquid channel to be above 60 degrees Celsius.

In certain embodiments, the arrangement is further configured to maintain the temperature of the relatively warmer liquid passing through the warm-liquid channel to be above 80 degrees Celsius.

In certain embodiments, the gap between the membrane and the relatively thin wall of the respective compartment for condensing gas into liquid is within the range 0.5-5 mm.

In certain embodiments, the gap between the membrane and the relatively thin wall of the respective compartment for condensing gas into liquid is within the range 0.5-2 mm.

In embodiments, the gap between the two side walls of the formed compartment of the warm-liquid channel is within the range 1-5 mm.

In embodiments, the gap between the two side walls of the formed compartment of the warm-liquid channel is within the range 2-4 mm.

In embodiments, the gap between the two the relatively thin walls of the formed compartment of the cooling channel is within the range 1-5 mm.

In embodiments, the gap between the two the relatively thin walls of the compartment of respective cooling channel is within the range 2-4 mm.

In embodiments, at least the inner surface of the respective membrane facing the compartment for condensing gas into liquid is made of a highly non-reactive material.

In embodiments, the structure of the plates is made of a highly non-reactive material. In certain embodiments, the structure of the plates is made of PolyVinylidene DiFluoride (PVDF).

In embodiments, the structure of the plates is made of a thermoplastic material. In certain embodiments, the structure of the plates is made of PolyPropylene (PP). In embodiments, at least the surface of the respective membrane facing the compartment for condensing gas into liquid is made of a fluoropolymer material.

In certain embodiments, the at least surface of the respective membrane facing the compartment for condensing gas into liquid is made of Poly TetraFluoroEthylene (PTFE). In certain embodiments, the respective membrane is made of PolyTetraFluoroEthylene (PTFE).

In embodiments, each of the plurality of plates have substantially the same dimensions. In certain embodiments, the height of each of the plurality of plates is within the range 15 to 25 centimeters, preferably between 18 to 22 centimeters.

In certain embodiments, the width of each of the plurality of plates is within the range 15 and 25 centimeters, and preferably between 18 to 22 centimeters. In embodiments, the height of the respective membrane inside the warm-liquid channel is between 16 and 24 centimeters.

In embodiments, the design and dimensions of the respective membrane is adapted to define a length of a substantially vertical flow path of the relatively warmer liquid along the surface of the respective membrane which is less than 22 centimeters.

In embodiments, the height of the structure of each of the plurality of plates is between 18 and 22 centimeters.

In embodiments, the height of the respective membrane inside the warm-liquid channel is between 16 and 21 centimeters.

In embodiments, the design and dimensions of the respective membrane is adapted to define a length of a substantially vertical flow path of the relatively warmer liquid along the surface of the respective membrane which is less than 22 centimeters.

In embodiments, the height of the structure of each plate is between 19 and 21 centimeters. In certain embodiments, the height of the respective membrane inside the warm-liquid channel is between 18 and 20.5 centimeters.

In embodiments, the design and dimensions of the respective membrane is adapted to define a length of a substantially vertical flow path of the relatively warmer liquid along the surface of the respective membrane which is less than 21 centimeters.

In embodiments, the respective plate structure defines a height of the cooling channel to be between 16 and 22 centimeters.

In embodiments, the joined plate structures define a length of a substantially vertical flow path of the relatively colder fluid along the surface on the other side of the relatively thin wall from the inner surface of the compartment for condensing gas into liquid which is less than 20 centimeters.

In embodiments, at least a substantial portion of the structure of each plate arranged opposite the membrane and having surface portions facing the membrane inside the compartment for condensing gas into liquid form a relatively thin wall. In certain embodiments, the relatively thin wall is at least partly made of a metallic material, thereby improving the heat transfer efficiency through the wall.

In aspects, the technology disclosed relate to a plate having structure where the structure includes a relatively thin wall adapted for efficient heat transfer from a relatively colder fluid passing along one side of the relatively thin wall for cooling of the other side of the relatively thin wall. The relatively thin wall is thereby adapted for efficient heat transfer providing a cooling effect so that liquid in gaseous can efficiently condense into droplets on the inner surface of the compartment for condensing gas into liquid.

According to aspects of the technology disclosed, the plate structure may comprise, as an integral part which may be injection moulded or 3D printed to form an integral part of the plate structure, at least one outlet for conveying liquid condensed from gaseous state into droplets away from the compartment for condensing gas into liquid.

In embodiments, the plate is configured to be joined to or comprise a membrane to thereby form a sealed compartment between the membrane and surface portions of the structure including the at least one outlet. The sealed compartment may then include the relatively thin wall to thereby be configured for efficiently condensing gas into liquid.

In embodiments, the thickness of the material forming the relatively thin wall is less than 2 mm, and the relatively thin wall is thereby adapted for efficient heat transfer for cooling of the inner surface of the sealed compartment for condensing gas into liquid. In certain embodiments, the thickness of the material forming the relatively thin wall is less than 1 mm, thereby being adapted for efficient heat transfer for cooling of the inner surface of the compartment for condensing gas into liquid.

In certain embodiments, the relatively thin wall of the plate structure is at least partly made of a metallic material, thereby improving the heat transfer efficiency through the relatively thin wall.

In aspects, the technology disclosed relates to an arrangement for at least one of separating and purifying a liquid where the arrangement comprises at least one plate and is configured to reduce the risk of leakage and significantly reduce the risk of external particles and other contaminants entering the arrangement. In certain embodiments, the object of the configuration of the arrangement according to the technology disclosed is to make separate cooling sheets and gaskets obsolete, thereby reducing the risk of leakage from the arrangement and significantly reducing the risk of external particles and other contaminants entering the arrangement, e.g. the warm-liquid channel.

In embodiments, the technology disclosed relates to an arrangement for purifying water by membrane distillation comprising a membrane distillation arrangement in association with the cleaning of water. It is necessary to clean water for a number of purposes. It may be a question of cleaning water for household use, desalting seawater for a purpose, cleaning water for use within several industrial fields, or concentrating undesired substances, i.e. a byproduct, to as small a volume as possible, or indeed to a solid material.

In embodiments, the liquid flowing in the warm-liquid channel as defined by the independent claim is water containing particles and the object of the technology disclosed is to provide an arrangement that can provide purify water to produce ultrapure water that reduces the risk of leakage and significantly reduces the risk of external particles and other contaminants entering the arrangement. In certain embodiments, the arrangement comprises at least one plate and is configured to make the use of separate cooling sheets and gaskets obsolete, thereby reducing the risk of leakage from the arrangement and significantly reducing the risk of external particles and other contaminants entering the arrangement.

In embodiments, the technology disclosed relates to an arrangement, a plate and a method for purifying a liquid with the aid of a liquid phobic membrane through which membrane only purified liquid in a gaseous state is caused to pass, whereby a liquid residual, which contains an elevated content of contaminants, does not pass through the liquid phobic membrane, and it is characterised in that the liquid is caused to flow in a first circuit comprising a liquid phobic membrane, in that the liquid in the first circuit is caused to pass a first heating arrangement, which is caused to heat the liquid in the first circuit, in that at least a portion of the first circuit is extended in the vertical direction, in that a closed additional second circuit is connected to the vertical part of the first circuit and in that the liquid in the additional second circuit is caused to be heated to a temperature that is higher than that of the liquid in the first circuit.

In embodiments, the technology disclosed relates to an arrangement, a plate and a method for cleaning water comprising membrane distillation, which distillation is caused to use differences in partial pressure with the aid of a hydrophobic membrane through which membrane only clean water in a gaseous state is caused to pass, whereby a water residual, which contains an elevated content of contaminants, does not pass through the membrane, and it is characterised in that the water is caused to flow in a first circuit comprising a membrane distillation arrangement, in that the water in the first circuit is caused to pass a first heating arrangement, which is caused to heat the water in the first circuit, in that at least a portion of the first circuit is extended in the vertical direction, in that a closed additional second circuit is connected to the vertical part of the first circuit and in that the water in the additional second circuit is caused to be heated to a temperature that is higher than that of the water in the first circuit.

In embodiments, the object of the technology disclosed is to provide an arrangement that can provide purified water for washing purposes in a semiconductor production line that reduces the risk of leakage and significantly reduces the risk of external particles and other contaminants entering the arrangement. In certain embodiments, the arrangement comprises at least one plate and is configured to make the use of separate cooling sheets and gaskets obsolete, thereby reducing the risk of leakage from the arrangement and significantly reducing the risk of external particles and other contaminants entering the arrangement.

In certain embodiments, the liquid as defined in the independent claim is at least one type of alcohol selected from the group of alcohols and the technology disclosed relates to an arrangement for purifying or separating the at least one alcohol by which particles and/or other substances are effectively removed from the liquid.

In certain embodiments, the liquid as defined in the independent claims is at least one type of oil and the technology disclosed relates to an arrangement for purifying or separating the at least one oil by which particles and/or other substances are effectively removed from the oil.

In certain embodiments, the liquid as defined in the independent claims is a liquid solution containing virus and the technology disclosed relates to an arrangement comprising at least one membrane for separating virus from the liquid solution.

In certain embodiments, the liquid as defined in the independent claims is a liquid solution containing minerals and the technology disclosed relates to an arrangement comprising at least one membrane for separating minerals from the liquid solution,

The arrangement according to the technology disclosed may be adapted for at least one of separating and purifying a liquid. The arrangement includes at least one plate comprising a structure. The arrangement further includes at least one membrane through which gaseous liquid can pass through but not fluid in liquid form. Peripheral surface portions of the membrane may be joined to outer surface portions of a first side of the respective plates structure so that the joined membrane is substantially parallel with and is facing a relatively thin wall constituting at least some of the more central portions of the plate structure. The peripheral surface portions of the membrane may then be directly joined to the outer surface portions of the plate structure to define a compartment, e.g. a substantially sealed compartment, configured for condensing gas into liquid and the compartment may then comprise at least one outlet as an integral part of the plate structure.

As mentioned above, the structure of the at least one plate may comprise at least one outlet for conveying fluid away from the compartment for condensing gas into liquid. Hence, the at least one outlet may constitute an integral/integrated part of the plate structure to thereby minimize the risk of leakage and significantly reduce the risk of external particles and other contaminants entering the arrangement, e.g. reduce the risk of leakage from the compartment for configured for condensing gas into liquid and reduce the risk of particles and other contaminants entering the compartment for configured for condensing gas into liquid.

According to aspects of the technology disclosed, the plates may be directly joined by welding the plates together, e.g. by laser welding or ultrasonic welding. However, welding is one type of joining process for directly joining the plates together; other examples include riveting, soldering, adhesive, brazing, coupling, fastening and press fit. Important advantages of the module of the technology disclosed comprising directly joined plates to form the compartments and their respective inlets and/or outlets include that the module does not have to comprise any gaskets, thereby reducing the risk of leakage and removing or significantly reducing the risk of particles entering the module.

In aspects and embodiments, the membrane is directly joined to the plate structure by focusing a laser beam along a closed welding line extending along the peripheral surface portions of the membrane and the outer surface portions of the plate structure, thereby defining a substantially sealed compartment configured for condensing gas into liquid comprising at least one opening or outlet.

In certain embodiments, a catalyst layer is used for directly joining the plates in that the catalyst layer is applied along a closed joining line extending along the peripheral surface portions of the membrane and the outer surface portions of the plate structure and in that the laser beam is focused along the same closed joining line, i.e. the closed welding line.

In embodiments of the method according to the technology disclosed, two plates are directly joined together to thereby form and define a compartment of a cooling channel without any intermediate gaskets.

In aspects and embodiments, the plates are joined together along a joining line extending along the outer surface portions of the respective plate structure to thereby form and define the compartment of a cooling channel.

In embodiments, the at least one inlet and at least one outlet of the compartment is formed and defined by the same joining line, e.g. the at least one inlet and at least one outlet of the compartment are defined by the outer portions of the plates which are not joined together.

In embodiments, at least some of the more central portions of each of the plate structure of each of the two plates which are joined together forms a relatively thin wall adapted for transferring heat from the cooling fluid of a cooling channel through the thin wall to cool down an inner surface of the respective compartment for condensing gas into liquid.

In embodiments of the method according to the technology disclosed, two plates are directly joined together by welding, e.g. laser welding or ultrasonic welding, to thereby form and define a compartment of a cooling channel without any intermediate gaskets.

In aspects and embodiments, the plates are joined together along a welding line extending along the outer surface portions of the respective plate structure to thereby form and define the compartment of a cooling channel.

In embodiments, the at least one inlet and at least one outlet of the compartment is formed and defined by the same welding line, e.g. the at least one inlet and at least one outlet of the compartment are defined by the outer portions of the plates which are not joined together by welding.

In embodiments, at least some of the more central portions of each of the plate structure of each of the two plates which are joined together by welding forms a relatively thin wall adapted for transferring heat from the cooling fluid of a cooling channel through the thin wall to cool down an inner surface of the respective compartment for condensing gas into liquid.

In embodiments of the method according to the technology disclosed, two plates are directly joined together by laser welding to thereby form and define a compartment of a cooling channel without any intermediate gaskets. In aspects and embodiments, the plates are joined together by focusing a laser beam along a welding line extending along the outer surface portions of the respective plate structure to thereby form and define the compartment of a cooling channel.

In embodiments, also the at least one inlet and at least one outlet of the compartment is formed and defined by the laser welding line, e.g. the at least one inlet and at least one outlet of the compartment are defined by the outer portions of the plates which are not joined together by laser welding.

In certain embodiments, a catalyst layer is used for directly joining the plates in that the catalyst layer is applied along a joining line extending along the peripheral surface portions of the membrane and the outer surface portions of the plate structure and in that the laser beam is focused along the same joining line, i.e. the laser welding line.

In embodiments, at least some of the more central portions of the plate structure of each of the two plates which are joined together by the laser welding forms a relatively thin wall adapted for transferring heat from the cooling fluid of a cooling channel through the thin wall to cool down an inner surface of the respective compartment for condensing gas into liquid.

In embodiments of the method according to the technology disclosed, two plates are directly joined together by gluing outer surface portions of the structures of the plates together to thereby form and define a compartment of a cooling channel without any intermediate gaskets.

In aspects and embodiments, the plates are joined together along a glue line extending along the outer surface portions of the respective plate structure to thereby form and define the compartment of a cooling channel. In embodiments also the at least one inlet and at least one outlet of the compartment are also formed and defined by the glue line, e.g. the at least one inlet and at least one outlet of the compartment are defined by the outer portions of the plates which are not glued together.

In embodiments, at least some of the more central portions of the plate structure of each of the two plates which are joined together by the gluing forms a relatively thin wall adapted for transferring heat from the cooling fluid of a cooling channel through the thin wall to cool down an inner surface of the respective compartment for condensing gas into liquid.

In embodiments of the method according to the technology disclosed, two plates are directly joined together to thereby define a compartment of a warm-liquid channel without any intermediate gaskets. In aspects and embodiments, the plates are joined together along a joining line extending along the outer surface portions of the respective plate structure to thereby form and define the compartment of a warm-liquid channel.

In embodiments, also the at least one inlet and at least one outlet of the compartment is formed and defined by the welding line, e.g. the at least one inlet and at least one outlet of the compartment are formed and defined by the outer portions of the plates which are not joined together.

In embodiments of the method according to the technology disclosed, two plates are directly joined together by welding, e.g. laser welding or ultrasonic welding, to thereby define a compartment of a warm-liquid channel without any intermediate gaskets.

In aspects and embodiments, the plates are joined together along a welding line extending along the outer surface portions of the respective plate structure, thereby defining the compartment of a warm-liquid channel.

In embodiments, also the at least one inlet and at least one outlet of the compartment is formed and defined by the welding line, e.g. the at least one inlet and at least one outlet of the compartment are formed and defined by the outer portions of the plates which are not joined together by welding.

In embodiments of the method according to the technology disclosed, two plates are directly joined together by laser welding to thereby form and define a compartment of a warm-liquid channel without any intermediate gaskets.

In aspects and embodiments, the plates are joined together by focusing a laser beam along a welding line extending along the outer surface portions of the respective plate structure to thereby form and define the compartment of a warm-liquid channel for carrying relatively warmer fluid in liquid form.

In embodiments, also the at least one inlet and at least one outlet of the compartment is formed and defined by the welding line, e.g. the at least one inlet and at least one outlet of the compartment are formed and defined by the outer portions of the plates which are not joined together by welding.

In certain embodiments, a catalyst layer is used for directly joining the plates in that the catalyst layer is applied along a joining line extending along the peripheral surface portions of the membrane and the outer surface portions of the plate structure and in that the laser beam is focused along the same joining line, i.e. the laser welding line.

In certain embodiments of the method according to the technology disclosed, two plates are directly joined together by gluing outer surface portions of the structures of the plates together, to thereby define a compartment of a cooling channel without any intermediate gaskets.

In aspects and embodiments, the plates are joined together along a glue line extending along the outer surface portions of the respective plate structure to thereby form and defining the compartment of a cooling channel.

In embodiments, also the at least one inlet and at least one outlet of the compartment is formed and defined by the glue line, e.g. the at least one inlet and at least one outlet of the compartment are formed and defined by the outer portions of the plates which are not glued together.

In embodiments, at least some of the more central portions of each of the plate structure of each of the two plates which are joined together by the gluing forms a relatively thin wall adapted for transferring heat from the cooling fluid of a cooling channel through the thin wall to cool down an inner surface of the respective compartment for condensing gas into liquid.

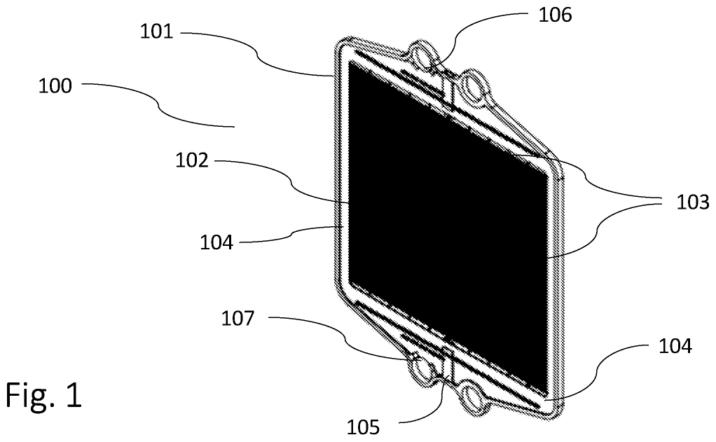

FIG. 1 shows a schematic front view of an example embodiment of the arrangement 100 and an example structure of a plate 101 according to the technology disclosed. The arrangement 100 depicted in FIG. 1 comprises a plate 101 having a structure. The arrangement further includes a membrane 102 through which gaseous liquid can pass through but not fluid in liquid form. Peripheral surface portions 103 of the membrane 102 are joined to surface portions of a first side 104 of the plate so that the joined membrane 102 is substantially parallel with and is facing a relatively thin wall constituting at least some of the more central portions of the plate structure (not shown). The peripheral surface portions 103 of the membrane are directly joined to the surface portions of the plate structure to form a compartment configured for condensing gas into liquid (not shown). The example embodiments of an arrangement depicted in FIG. 1 may constitute a separate module with only one compartment for condensing gas into liquid and producing purified or separated liquid or may be joined to other plates to form a module built-up from the joining of a plurality of plates in a stack, e.g. a module comprising a plurality of compartments each configured for condensing gas into liquid and producing purified or separated liquid.

In FIG. 1, the structure of the at least one plate also comprises an outlet 105 for conveying fluid away from the compartment for condensing gas into liquid. The outlet 105 depicted in FIG. 1 is an integral part of the plate structure, thereby minimizing the risk of leakage and significantly reducing the risk of external particles and other contaminants entering the compartment for condensing gas into liquid.

The structure of the example embodiments of a first side of a plate shown in FIG. 1 comprises one incision 106 in one of the circular holes forming part of the edge structure at the top edge of the plate and one incision 107 in one of the circular holes forming part of the edge structure at the bottom edge of the plate. When two first sides 104 of two plates corresponding to the plate in FIG. 1 are joined together at least one inlet and at least one outlet of a compartment of a warm-liquid channel are defined by joining the plates together in that the two incisions 106, 107 of one plate meet their respective incision to form an opening defining the inlet and outlet, respectively. When two second sides (not shown) of two plates corresponding to the plate in FIG. 1 are joined together at least one inlet and at least one outlet of a compartment of a cooling channel are defined by joining the plates together in that the two incisions of one plate (not shown in FIG. 1) meet their respective incision to form openings defining the inlet(s) to the compartment of a cooling channel and the outlet(s) from the compartment of a cooling channel, respectively.

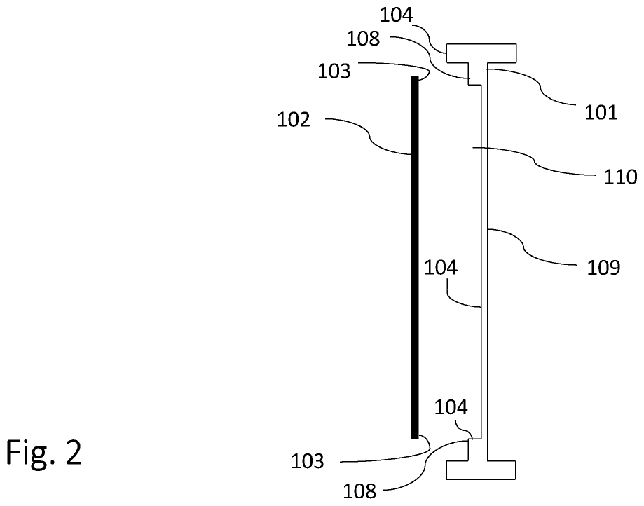

FIG. 2 shows a schematic side view of a plate 101 and a membrane 102 according to the technology disclosed. Outer peripheral surface portions 103 of the membrane 102 are to be joined to surface portions 108 of a first side 104 of the structure of the plate so that the joined membrane 102 is substantially parallel with and is facing a relatively thin wall constituting at least some of the more central portions 109 of the structure of the plate 101. In the example embodiment of a plate 101 depicted in FIG. 2, the more central portions of the structure of the plate consists of a cavity 110 where the cavity bottom is a relatively thin wall 109. The peripheral surface portions 103 of the membrane 102 are to be directly joined to the surface portions 108 of a first side 104 of the plate 101 to form a compartment configured for condensing gas into liquid. The peripheral surface portions 103 of the membrane 102 are joined to surface portions 108 surrounding the cavity 110 in the first side 104 of the structure so that the joined membrane 102 is substantially parallel with and is facing a relatively thin wall 109 constituting the cavity bottom of the cavity 110 in the first side 104 of the plate 101.

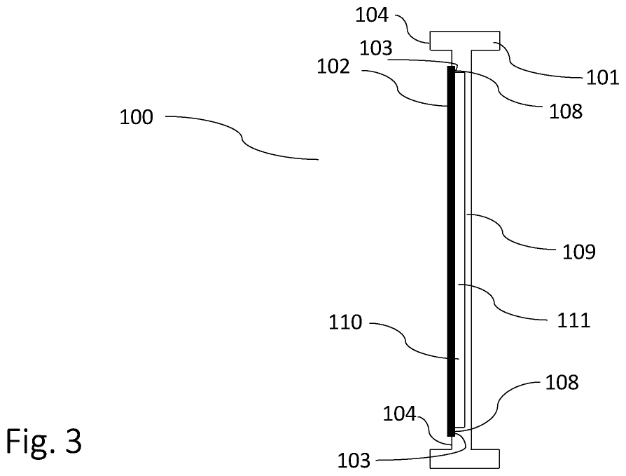

FIG. 3 illustrates a schematic side view of an arrangement 100 comprising a membrane 102 through which gaseous liquid can pass through but not fluid in liquid form and which has been joined to the structure of an example embodiment of a plate 101 according to the technology disclosed. In FIG. 3, the joined membrane 102 is substantially parallel with and is facing a relatively thin wall 109 constituting the more central portions of the plate 101. The membrane 102 in FIG. 3 is directly joined to the plate 101 to form and define a compartment for condensing gas into liquid 111. The arrangement 100 depicted in FIG. 3 also comprises an outlet for conveying fluid away from the compartment for condensing gas into liquid (not shown). The peripheral surface portions 103 of the membrane 102 are joined to surface portions 108 of a first side 104 of the structure of the plate 101 so that the joined membrane 102 is substantially parallel with and is facing a relatively thin wall 109 constituting some of the more central portions of the plate structure. The peripheral surface portions 103 of the membrane 102 shown in FIG. 3 are directly joined to the surface portions 108 of the plate 101 to form a compartment for condensing gas into liquid 111, i.e. a compartment for condensing gaseous liquid substance into a liquid state. The cavity 110, or depression, in the first side 104 of the plate in FIG. 3 enables the forming of a (sealed) compartment for condensing gas into liquid 111 when joining the peripheral surface portions 103 of the membrane 102 to surface portions 108 surrounding the cavity in the first side 104 of the plate 101.

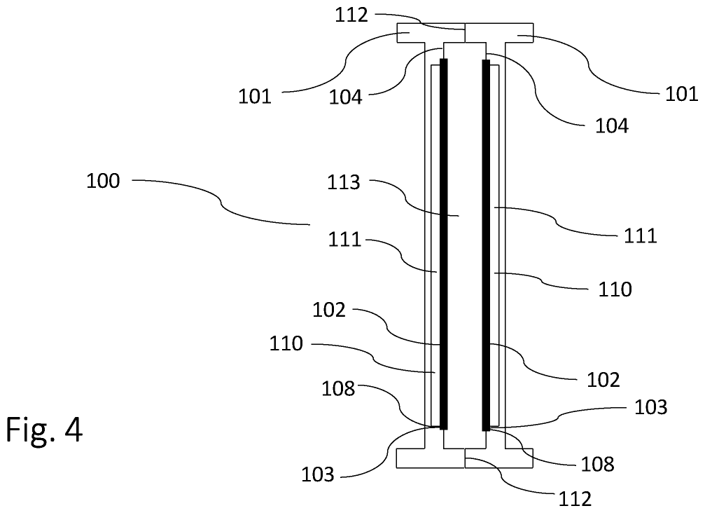

FIG. 4 illustrates a schematic side view of an arrangement 100 comprising two plates 101 where each of the two plates has a membrane 102 joined to a first side 104 of the structure of the respective plate 101. In FIG. 4, outer peripheral surface portions 112 of the same first side 104 of the structure of the respective plate as the membrane 102 is joined to the plate structure are joined to outer peripheral surface portions 112 of the first side 104 of the structure of the second plate 101 to thereby form, in addition to the two compartments for condensing gas into liquid, a first type of compartment of a warm-liquid channel for carrying relatively warmer liquid 113. The compartment of a warm-liquid channel 113 that is schematically illustrated in FIG. 4 is configured so that relatively warmer liquid may pass along the substantially parallel and in the compartment of the warm-liquid channel 113 opposing membranes 102 of the two respective compartments for condensing gas into liquid 111. The cavity 110, or depression, in the first side 104 of the respective plate 101 in FIG. 4 enables the forming of a (sealed) compartment for condensing gas into liquid 111 when joining the peripheral surface portions 103 of the membrane 102 to surface portions 108 surrounding the cavity in the first side 104 of the respective plate 101. By directly joining outer peripheral surface portions 112 of the respective same first side 104 of two plates 101 together, a compartment of a warm-liquid channel 113 including the respective membrane 102 of the two plates 101 can be formed.

Hence, the two plates 101 whose joining form and define the compartment of a warm-liquid channel 113 are joined together on the same first side 104 of the respective plate structure as the side to which the respective membrane 102 is joined to the plate structure. Typically, outer peripheral surface portions 112 of two plates 101 are then joined to each other on the same first side 104 of the respective plate structure as the respective membrane is joined to the plate structure and the distance between the two membranes 102 along a substantially normal axis to the plane of the membranes 102 essentially defines the gap of the compartment of the warm-liquid channel 113.

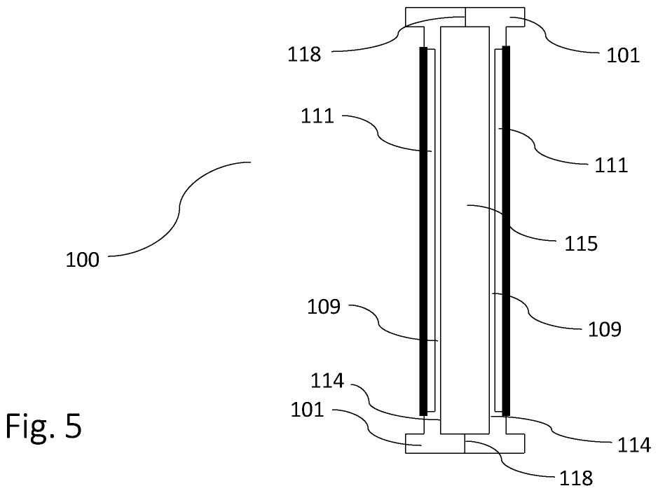

FIG. 5 illustrates a schematic side view of an example arrangement 100 where a second side 118 of two plates 101 are joined together to form a second type of compartment 115 for a cooling channel.

In FIG. 5, outer surface portions 118 of the second side 114 of the structure of the two plates 101 are joined together to thereby form and define a second type of compartment of a cooling channel 115 for carrying cooling fluid. The compartment of a cooling channel 115 schematically illustrated in FIG. 5 is configured for cooling of an inner surface of the respective compartment for condensing gas into liquid 111 by heat transfer from a cooling fluid flowing in the cooling channel through the relatively thin wall 109 constituting at least some of the more central portions of the structure of the respective plate 101.

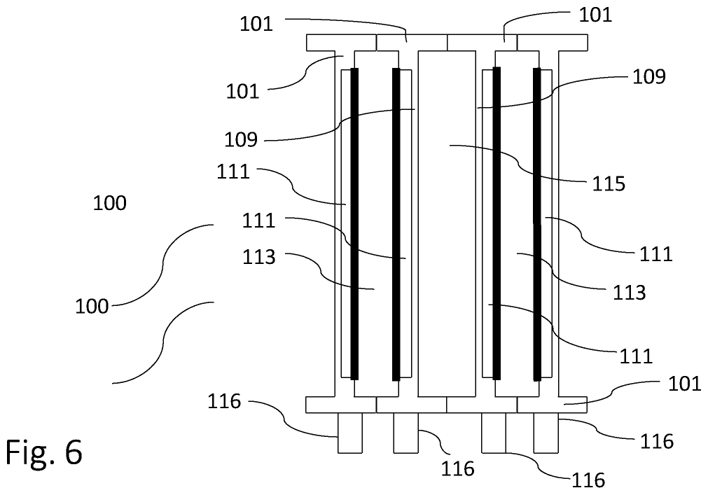

FIG. 6 illustrates a schematic side view of an example arrangement 100 according to the technology disclosed comprising four plates 101 whose joining has formed and defined four (substantially sealed) compartments for condensing gas into liquid 111, i.e. for condensing a gaseous liquid substance into liquid state, each of the compartments for condensing gas into liquid 111 comprises an outlet (not shown), two compartments for a warm-liquid channel 113 for carrying relatively warmer liquid and one compartment of a cooling channel 115 for carrying cooling fluid. The compartment of a cooling channel 115 shown in FIG. 6 comprises two relatively thin walls 109, each configured for transferring heat from a cooling fluid flowing in the cooling channel to the inner surface of the respective compartment for condensing a gas into liquid 111.

The arrangement 100 shown in FIG. 6 further comprises four collection containers 116 for conveying fluid away from the respective compartment for condensing gas into liquid 111. The collection containers 116 are connected to the outlet (not shown) for conveying fluid away from the respective compartment for condensing gas into liquid 111. The collection containers 116 shown in FIG. 6 are each adapted for collecting at least one of purified or separated liquid from their respective compartment for condensing gas into liquid 111. In embodiments, the collection containers 116 in FIG. 6 may be directly joined to the plate structure or may be an integral part of the respective plate structure.

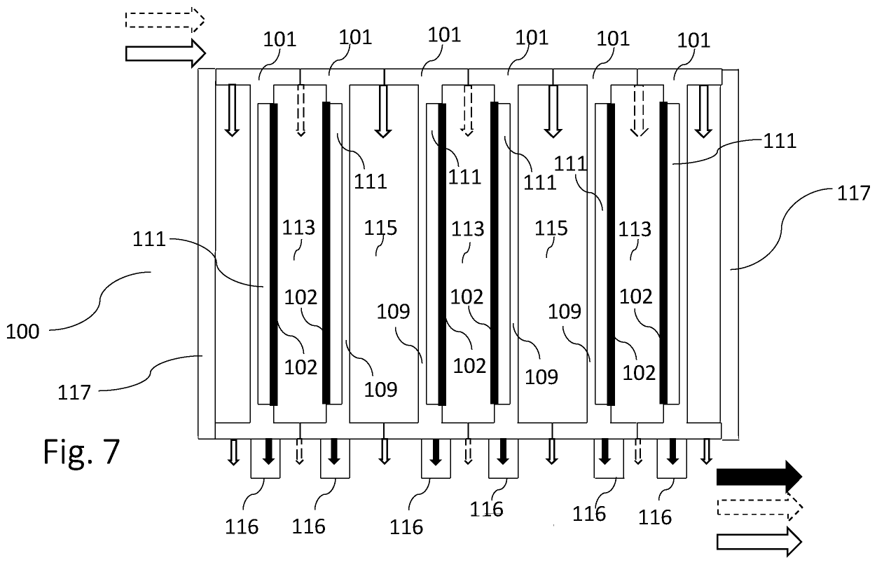

FIG. 7 illustrates a schematic side view of an example arrangement according to the technology disclosed comprising two end plates 117 and six mutually similar plates 101 whose joining has formed and defined six (substantially sealed) compartments for condensing gas into liquid 111, i.e. for condensing a gaseous liquid substance into liquid state, each of the compartments for condensing gas into liquid 111 comprises an outlet (not shown), three compartments for a warm-liquid channel 113 for carrying relatively warmer liquid and two compartments of a cooling channel 115 for carrying cooling fluid. Each of the two compartments of a cooling channel 115 shown in FIG. 7 comprises two relatively thin walls 109, each configured for transferring heat from a cooling fluid flowing in the cooling channel to the inner surface of the respective compartment for condensing a gas into liquid 111.

The arrangement shown in FIG. 7 further comprises six collection containers 116 for conveying fluid away from their respective compartment for condensing gas into liquid 111. The collection containers are connected to their respective outlet (not shown) for conveying fluid away from the respective compartment for condensing gas into liquid. The collection containers 116 shown in FIG. 7 are thus adapted for collecting fluid from their respective compartment for condensing gas into liquid. In embodiments, the collection containers in FIG. 7 may be directly joined to their respective plate structure or may be an integral part of the respective plate structure.

The dashed arrows in FIG. 7 illustrate the flow of relatively warmer through the warm-liquid channel and the compartments of the warm-liquid channel 113 formed and defined by the joining of the plates 101. The compartments of a warm-liquid channel 113 in the arrangement 100 schematically illustrated in FIG. 7 may be part of a closed loop sub-system (not shown) for recirculating portions of the relatively warmer liquid passing along the membranes 102. The system for purifying or separating a liquid may further comprise a heating element for heating the liquid flowing through the closed loop sub-system (not shown), e.g. adapted for keeping the temperature of the relatively warmer liquid above a certain temperature. A pump is typically then used in the arrangement to pump the relatively warmer liquid around in the closed loop sub-system for recirculating the relatively warmer liquid.

The white arrows in FIG. 7 illustrate the flow of a cooling fluid through the cooling channel and the compartment of the cooling channel 115 formed and defined by the joining of the plates 101. Each of the compartments of a cooling channel 115 shown in FIG. 7 comprises two relatively thin walls 109, each configured for transferring heat from a cooling fluid flowing in the cooling channel to the inner surface of the respective compartment for condensing a gas into liquid 111. The compartments of a cooling channel 115 in the arrangement schematically illustrated in FIG. 7 may be part of a closed loop sub-system for recirculating the cooling fluid (not shown). The cooling fluid may be a cooling liquid or cooling gas and the system/arrangement for purifying or separating a liquid may then comprise a cooling element (not shown) for cooling the cooling fluid flowing through the closed loop sub-system, e.g. the cooling element may be adapted for keeping the temperature of the cooling fluid below a certain temperature. A pump is typically then used in the arrangement 100 to pump the cooling fluid around in the closed loop sub-system for recirculating the cooling fluid.

The solid arrows in FIG. 7 illustrate the flow of purified or separated liquid conveyed away from the respective compartment for condensing gas into liquid 111 and which is collected by the respective collection container 116. The respective collection container 116 may, in turn, comprise an outlet (not shown).

According to embodiments, the technology disclosed relates to an arrangement or module for at least one of separating and purifying a liquid where the arrangement comprises a plurality of plates joined together in a stack. Each of the plates may then comprise a structure made of polymer and/or metallic material and a membrane through which the liquid in gaseous form can pass but not fluid in liquid form. The membrane is joined to, or is injection moulded to be an integral part of, a first side of the structure of the respective plate to form a respective compartment between the membrane and surface portions of the respective plate structure. The compartment is adapted for condensing fluid in gaseous form into liquid form and the structure of the respective plate may include, as an integral part of the plate structure, at least one outlet for conveying fluid away from the compartment for condensing gas into liquid, without any need for gaskets or seals.

The arrangement, or module, may then comprise at least two plates where portions of a first side of the structure of a first plate are joined to portions of a first side of the structure of a second plate to form a compartment of a warm-liquid channel including at least one inlet and at least one outlet. The warm-liquid channel may be configured for continuously carrying relatively warm liquid along the membrane of the respective plate so that liquid in gaseous from may pass through the respective membrane and be condensed on the inner surface of the respective compartment for condensing gas into liquid.

The at least one outlet of the compartment for condensing gas into liquid form an integral part of the structure of the respective plate. In embodiments, the membrane of the respective plates may be at least one of welded to and injection moulded as part of the first side of the structure of the respective plate to thereby form the compartment for condensing gas into liquid which comprise the at least one outlet for conveying fluid away from the compartment for condensing gas into liquid.

The arrangement, or module, may then comprise at least two plates where portions of a second side of the structure of a first plate are directly joined to portions of a second side of the structure of a second plate to form a compartment of a cooling channel including at least one inlet to the compartment and at least one outlet from the compartment. The directly joined plates may form a compartment of a cooling channel for the flow of a cooling fluid, e.g. a cooling liquid or a cooling gas.

At least substantial portions of the structure of each plate arranged opposite the membrane and having surface portions facing the membrane inside the compartment for condensing gas into liquid may form a relatively thin wall adapted for efficient transfer of heat from a stream of cooling fluid continuously flowing in the cooling channel and through the relatively thin wall to thereby provide a cooling effect on the inner surface of the compartment for condensing gas into liquid. The direct joining of two plates each comprising at least one impermeable membrane to form a compartment of a cooling channel for carrying a cooling fluid and the provision of the relatively thin wall of the respective plate enable an arrangement, or module, for efficient production of purified liquid.

1. An arrangement for at least one of separating and purifying a liquid consisting of at least one plate comprising a structure and where the arrangement further includes a membrane through which gaseous liquid can pass but not fluid in liquid form, wherein surface portions of the membrane are joined to surface portions of a first side of the structure of the at least one plate so that the joined membrane is substantially parallel with and is facing a relatively thin wall constituting at least some of the more central portions of said plate structure, and wherein said surface portions of the membrane are directly joined to the surface portions of the plate structure to form a compartment for condensing gas into liquid.

2. The arrangement according to claim 1, wherein the first side of each of the at least one plate is provided with a cavity, and wherein said surface portions of the membrane are joined to surface portions surrounding the cavity to thereby form and define the compartment for condensing gas into liquid.

3. The arrangement according to claim 2, wherein said surface portions of the membrane are joined to the first side in a closed joining line surrounding said cavity to thereby form and define a sealed compartment for condensing gas into liquid.

4. The arrangement according to claim 1, wherein the structure of the at least one plate comprises at least one outlet for conveying fluid away from said compartment for condensing gas into liquid, and wherein said at least one outlet constitutes an integral part of the plate structure, thereby minimizing the risk of leakage and significantly reducing the risk of external particles and other contaminants entering the at least one of separated and purified liquid conveyed away from the compartment for condensing gas into liquid.

5. The arrangement according to claim 1, wherein said surface portions of the membrane are joined to surface portions of the first side so that the distance along a substantially normal axis to plane of the relatively thin wall to the membrane forms and defines the air gap of the compartment for condensing gas into liquid.

6. The arrangement according to claim 1, wherein outer peripheral surface portions of the same first side of the structure of one plate are joined to outer peripheral surface portions of the first side of the structure of another second plate comprising a membrane to thereby form, in addition to the compartments for condensing gas into liquid, a first type of compartment of a warm-liquid channel for carrying relatively warmer liquid, wherein said formed first type of compartment of a warm-liquid channel is configured so that relatively warmer liquid may pass along two substantially parallel and in said compartment of the warm-liquid channel opposing membranes of the two respective compartments for condensing gas into liquid.

7. The arrangement according to claim 6, wherein the two plates whose joining form and define the compartment of the warm-liquid channel are joined together on the same first side of the respective plate as the first side to which the respective membrane is joined to the respective plate.

8. The arrangement according to claim 7, wherein outer peripheral surface portions of two plates are joined to each other on the same first side of the respective plate structure as the respective membrane is joined to the respective plate, and wherein the distance between the two membranes along a substantially normal axis to the planes of the membranes defines the gap of the compartment of the warm-liquid channel.

9. The arrangement according to claim 6, wherein said two plates are joined to each other to also form and define at least one inlet and at least one outlet for said compartment of the warm-liquid channel.

10. The arrangement according to claim 6, wherein said plates are directly joined to each other without any intermediate gaskets, thereby reducing or eliminating the risk of leakage and contamination.

11. The arrangement according to claim 1, wherein surface portions of the second side of the first side of the structure of one plate are joined to surface portions of the second side of the structure of another third plate different from said second plate to thereby define a second type of compartment of a cooling channel for carrying a cooling fluid, and wherein said compartment of a cooling channel and the thickness of the relatively thin wall of the respective plate is adapted for cooling of an inner surface of the respective compartment for condensing gas into liquid by heat transfer from the cooling fluid through the relatively thin wall constituting at least some of the more central portions of the structure of the respective plate.

12. The arrangement according to claim 11, wherein said two plates are joined to each other to form and define at least one inlet and at least one outlet for said compartment of the cooling channel.

13. The arrangement according to claim 11, wherein said plates are directly joined to each other without any intermediate gaskets, thereby reducing or eliminating the risk of leakage.

14. The arrangement according to claim 1, wherein the structure of the at least one plate is configured so that the thickness of at least some of the more central portions of the structure of the at least one plate defines a relatively thin first wall adapted for transferring heat from a cooling fluid of a cooling channel through the thin wall to cool down an inner surface of the compartment for condensing gas into liquid.

15. The arrangement according to claim 14, wherein the thickness of the at least some of the more central portions of the plate structure defining a relatively thin first wall of the at least one plate is less than 2 mm, wherein the relatively thin wall is thereby adapted for efficient heat transfer for cooling of the inner surface of the compartment for condensing gas into liquid.

16. The arrangement according to claim 14, wherein the thickness of the at least some of the more central portions of the plate structure defining a relatively thin first wall of the at least one plate is less than 1 mm, wherein the relatively thin wall is thereby adapted for efficient heat transfer for cooling of the inner surface of the compartment for condensing gas into liquid.

17. The arrangement according to claim 14, wherein the at least some of the more central portions of the plate structure defining the relatively thin first wall of the at least one plate is at least partly made of a separate material from the material of the rest of the plate structure.

18. The arrangement according to claim 15, wherein the at least some of the more central portions of the plate structure defining the relatively thin first wall of the at least one plate is at least partly made of a metallic material coated with a film of a non-metallic material.

19. The arrangement according to claim 17, wherein said relatively thin first wall of the at least one plate is at least partly defined by a sheet at least partly made of a separate material from the polymer material of the rest of the plate structure, and wherein said sheet is joined to or is an integral part of the plate structure.

20. The arrangement according to claim 17, wherein a sheet or applied thin layer at least partly made of a metallic material at least partly forms and defines the relatively thin first wall of the at least one plate.

21. The arrangement according to claim 20, wherein said sheet or applied thin layer at least partly made of a metallic material is an integral part of the plate structure.

22. The arrangement according to claim 1, further comprising a collection container joined to the plate structure and connected to the at least one outlet for conveying fluid away from the respective compartment for condensing gas into liquid, wherein said collection container is directly joined to the plate structure and is adapted for collecting fluid from the compartment for condensing gas into liquid.

23. The arrangement according to claim 22, wherein said collection container is directly joined to the plate structure without any intermediate gaskets for connecting the at least one outlet for conveying fluid away from the respective compartment for condensing gas into liquid to the collection container, thereby reducing or eliminating the risk of leakage and contamination.

24. The arrangement according to claim 11, wherein the two different types of compartments of a cooling channel and a warm-liquid channel which comprises the respective at least one inlet and at least one outlet of each compartment are each defined by the respective directly joined two plates so that each unit for condensing gas into liquid is directly defined by said joined plates without any intermediate gaskets for the inlets and outlets for the respective compartment, thereby reducing or eliminating the risk of leakage and contamination from inside and outside the arrangement.

25. A plate having a structure and configured to be joined to a membrane through which gaseous liquid can pass through but not fluid in liquid form, wherein the structure of a first side of the plate is configured so that a membrane that is joined to the first side is substantially parallel with and is facing a relatively thin wall constituting at least some of the more central portions of the plate and the distance between the relatively thin wall and the membrane defines the air gap of a compartment for condensing gas into liquid.

26. The plate according to claim 25, wherein the first side of the plate is provided with a cavity, and wherein said cavity is configured so that, when surface portions of a membrane are joined to surface portions surrounding the cavity in the first side of the plate, a compartment for condensing gas into liquid is formed.

27. The plate according to claim 26, wherein said cavity is configured so that, when surface portions of the membrane are joined to the first side in a closed joining line surrounding said cavity, a sealed compartment for condensing gas into liquid is formed.

28. The plate according to claim 25, wherein the plate comprises at least one outlet constituting an integral part of the structure.

29. The plate according to claim 25, wherein the plate structure comprises a membrane part which is at least one of injection moulded and 3D printed to be an integral part of the structure.
